(19) United States
(12) Patent Application Publication
(10) Pub. No.: US 2024/0380521 A1
(43) Pub. Date: Nov. 14, 2024

(54) EARLY HYBRID AUTOMATIC REPEAT REQUEST PROCESS TERMINATION

(71) Applicant: QUALCOMM Incorporated, San Diego, CA (US)

(72) Inventors: Diana MAAMARI, San Diego, CA (US); Wei YANG, San Diego, CA (US); Mickael MONDET, Louannec (FR); Ahmed ELSHAFIE, San Diego, CA (US); Huilin XU, Temecula, CA (US)

(21) Appl. No.: 18/317,030

(22) Filed: May 12, 2023

(51) Int. Cl. H04L 1/1812; H04L 5/00; H04W 72/21

(52) U.S. Cl. CPC H04L 1/1812; H04L 5/0055; H04W 72/21

(57) ABSTRACT

In an aspect, a UE may obtain a first indication of a time period in which UCI is to be transmitted, where the UCI includes at least one bit that indicates at least one HARQ process number of at least one first HARQ process that is to be terminated at the UE. The UE may transmit the UCI during the time period based on the first indication. The UE may refrain from transmitting of at least one transport block associated with the at least one first HARQ process based on the at least one bit in the UCI.

### TECHNICAL FIELD

The present disclosure relates generally to communication systems, and more particularly, to hybrid automatic repeat request (HARQ)-based communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. The at least one processor, based at least in part on information stored in the at least one memory may be configured to obtain a first indication of a time period in which uplink control information (UCI) is to be transmitted, where the UCI includes at least one bit that indicates at least one HARQ process number of at least one first HARQ process that is to be terminated at the UE, to transmit the UCI during the time period based on the first indication, and to refrain from a transmission of at least one transport block associated with the at least one first HARQ process based on the at least one bit in the UCI.

In another aspect of the disclosure, a method, a computer-readable medium, and an apparatus at a network node are provided. The apparatus may include at least one memory and at least one processor coupled to the at least one memory. The at least one processor, based at least in part on information stored in the at least one memory may be configured to provide, for a UE, a first indication of a time period in which UCI is to be transmitted, where the UCI includes at least one bit that indicates at least one HARQ process number of at least one first HARQ process that is to be terminated, to receive the UCI during the time period based on the first indication, and to refrain, based on the at least one bit, from a transmission of downlink control information (DCI) configured to schedule a retransmission of at least one transport block associated with the at least one first HARQ process.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram 400 illustrating a HARQ process in accordance with various aspects described herein.

FIG. 5A illustrates a diagram for transmitting a UCI-HARQ Process Number Termination (HPNT) in accordance with various aspects of the present disclosure.

FIG. 5B illustrates a diagram for transmitting a UCI-HPNT in accordance with various aspects of the present disclosure.

FIG. 5C illustrates a diagram for transmitting a UCI-HPNT in accordance with various aspects of the present disclosure.

FIG. 6 illustrates a diagram for transmitting a UCI-HPNT in accordance with various aspects of the present disclosure.

FIG. 7 is a diagram illustrating the transmission of a multiplexed signal on a physical uplink shared channel (PUSCH) in accordance with various embodiments of the present disclosure.

FIG. 8 is a table illustrating various configured grant (CG)-UCI fields in accordance with various embodiments of the present disclosure.

FIG. 9 is a call flow diagram illustrating a method of wireless communication in accordance with various aspects of the present disclosure.

FIG. 10 is a flowchart illustrating methods of wireless communication in accordance with various aspects of the present disclosure.

FIG. 11A is a flowchart illustrating methods of wireless communication in accordance with various aspects of the present disclosure.

FIG. 11B is a flowchart illustrating methods of wireless communication in accordance with various aspects of the present disclosure.

FIG. 11C is a flowchart illustrating methods of wireless communication in accordance with various aspects of the present disclosure.

FIG. 12 is a flowchart illustrating methods of wireless communication in accordance with various aspects of the present disclosure.

FIG. 13 is a flowchart illustrating methods of wireless communication in accordance with various aspects of the present disclosure.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

Various aspects of the present disclosure, in connection with the accompanying drawings, relate generally to communication systems. Some aspects more specifically relate to the early termination of HARQ process(es). In some examples, a UE may indicate, to a network node, HARQ process number identifier(s) (ID(s)) of HARQ process(es) that are to be early terminated (e.g., due to the expiration of a packet delay budget). The UE may indicate the HARQ process number ID(s) in UCI. The UCI may be transmitted based on a time period specified by the network node. The network node may refrain from transmitting, to the UE, downlink control information (DCI) configured to schedule a retransmission of transport block(s) associated with the HARQ process(es) that are identified in the UCI. The UE may refrain from retransmitting the transport block(s) as a result of not receiving the DCI, as the UE is not scheduled to transmit such transport block(s).

Particular aspects of the subject matter described in this disclosure can be implemented to realize one or more of the following potential advantages. In some examples, by early terminating HARQ process(es), the UE may conserve compute resources (e.g., processing cycles, memory, power, etc.) by limiting the retransmissions of data.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

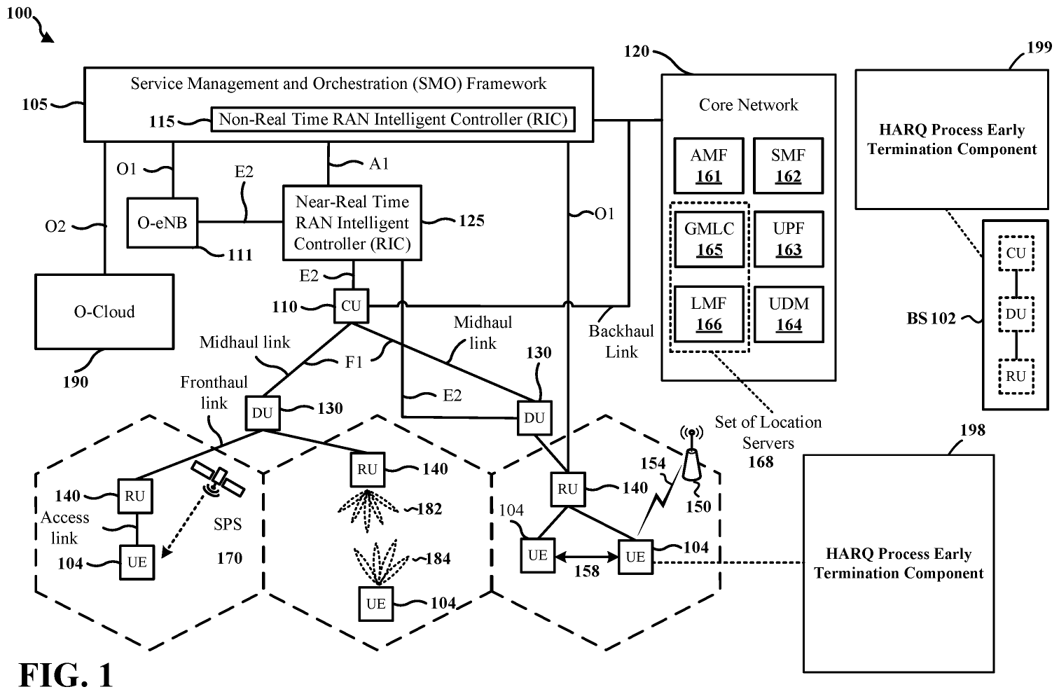

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a HARQ process early termination component 198 that may be configured to obtain a first indication of a time period in which UCI is to be transmitted, where the UCI includes at least one bit that indicates at least one HARQ process number of at least one first HARQ process that is to be terminated at the UE, to transmit the UCI during the time period based on the first indication, and to refrain from a transmission of at least one transport block associated with the at least one first HARQ process based on the at least one bit in the UCI. In certain aspects, the base station 102 may have a HARQ process early termination component 199 that may be configured to provide, for a UE, a first indication of a time period in which UCI is to be transmitted, where the UCI includes at least one bit that indicates at least one HARQ process number of at least one first HARQ process that is to be terminated, to receive the UCI during the time period based on the first indication, and to refrain, based on the at least one bit, from a transmission of downlink control information (DCI) configured to schedule a retransmission of at least one transport block associated with the at least one first HARQ process.

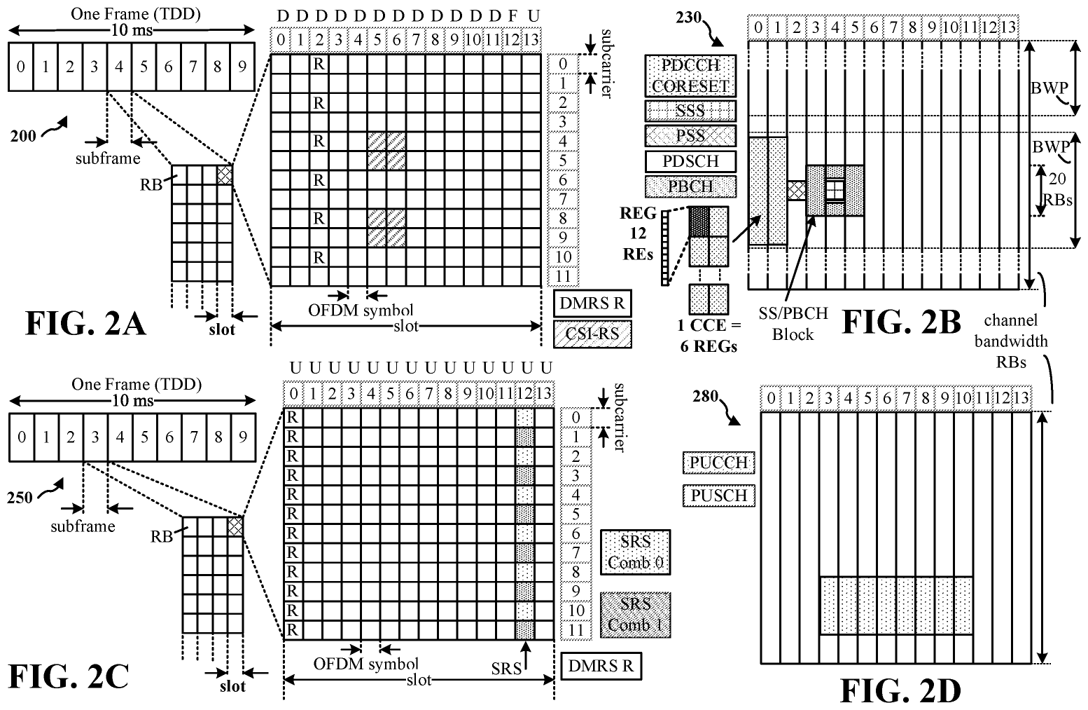

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| | Δf = 2^{μ} · 15 | Cyclic |
| μ | [kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology u=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology u=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

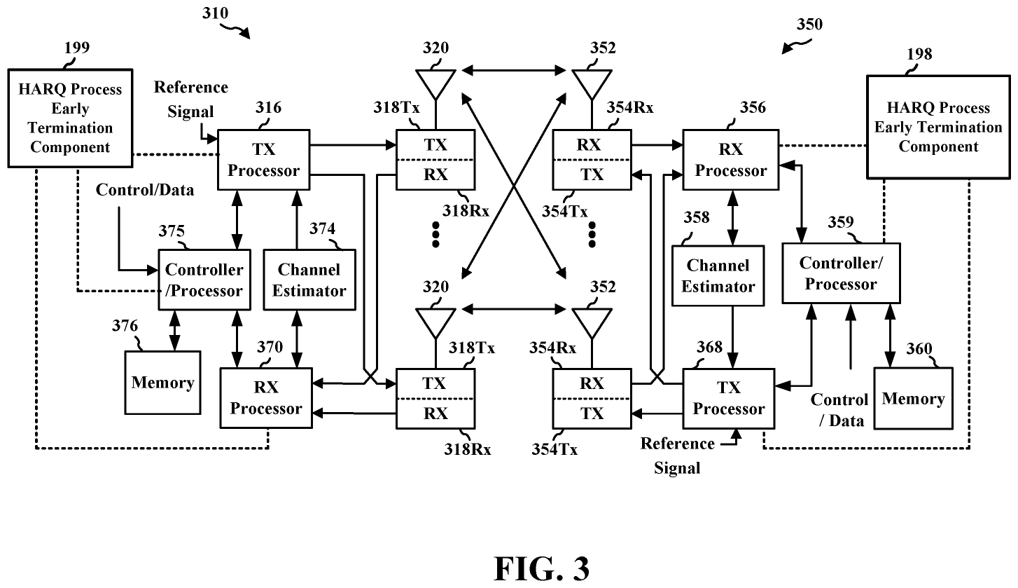

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the HARQ process early termination component 198 of FIG. 1.

At least one of the TX processor 316, the RX processor 370, and the controller/processor 375 may be configured to perform aspects in connection with the HARQ process early termination component 199 of FIG. 1.

HARQ is a stop and wait (SAW) protocol with multiple processes. HARQ is implemented to correct erroneous packets receiving via the PHY layer. If the received data is erroneous, then the receiver buffers the data and requests for a retransmission from the sender. When the receiver receives the retransmitted data, it then combines it with buffered data prior to channel decoding and error detection. This assists in the performance of retransmissions. To enable this, the sender buffers the transmitted data until the ACK is received, as the data is retransmitted in the event that a NACK is received. The HARQ protocol continues to repair one transmission without hindering other ongoing transmission, which may continue in parallel.

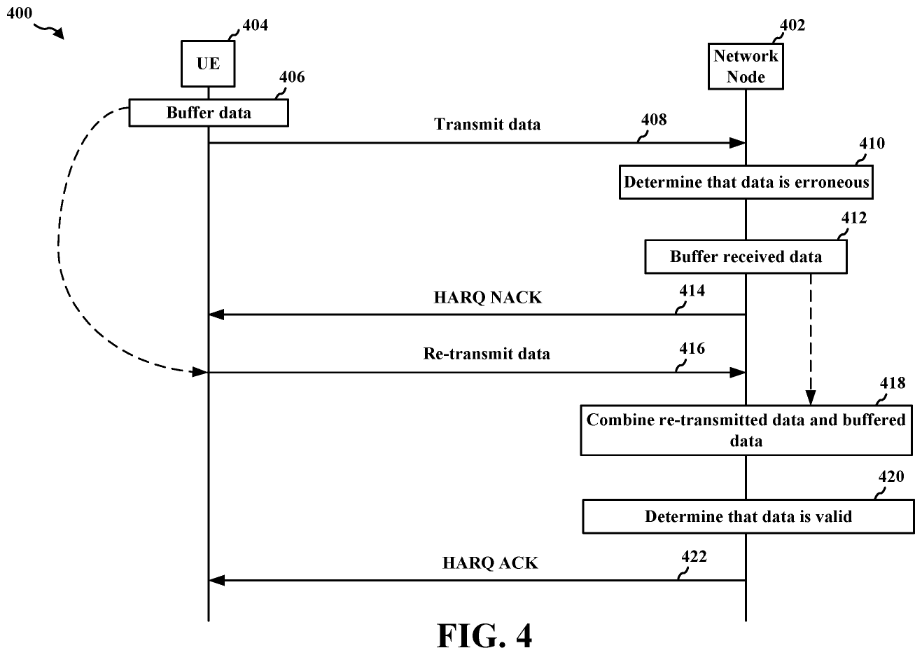

FIG. 4 is a call flow diagram 400 illustrating a HARQ process in accordance with various aspects described herein. As shown in FIG. 4, the call flow diagram 400 includes a network node 402 and a UE 404. The UE 404 may be an example of the UE 104 or the UE 350. The network node 402 may be an example of the base station 102 or the base station 310. Although aspects are described for the network node 402, the aspects may be performed by the network node 402 in aggregation and/or by one or more components of the network node 402 (e.g., such as a CU 110, a DU 130, and/or an RU 140). As shown in FIG. 4, at 406, the UE may buffer data (e.g., a transport block) to be transmitted to the network node 402.

At 408, the UE may transmit the data for a first HARQ process to the network node 402 and waits for either a HARQ ACK or a HARQ NACK. It is noted that while the UE 404 waits for a HARQ ACK or a HARQ ACK, the UE may transmit data for one or more other HARQ processes. At 410, the network node 402 may determine that the data received from the UE 404 is erroneous. In response, at 412, the network node 402 may buffer the received data, and at 414, the network node 402 may transmit a HARQ NACK. At 416, the UE retrieves the data buffered at 406 and retransmits the data to the network node 402. At 418, the network node 402 may soft combine the data retransmitted at 416 with the data buffered at 410. For instance, the PHY layer may apply different puncturing patterns to the original transmission at 408 and the retransmission at 416. This results in a retransmission that includes a different set of PHY layer bits than the original transmission. The first transmission may provide the systematic bits with the greatest priority, while subsequent retransmissions may provide either the systematic bits, the parity 1 bits, and/or the parity 2 bits with greatest priority. Soft combining the original transmission and the retransmission (having a different set of bits) may result in a single, combined packet that is more reliable than the original transmission or the retransmission alone. At 420, the network node 402 may determine that the data is valid based on the soft combining of the original transmission and the retransmission and, at 422, may provide a HARQ ACK to the UE 404. It is noted that while FIG. 4 illustrates an uplink-based HARQ process in which the UE 404 transmits data to the network node 402, waits for a HARQ ACK or HARQ NACK from the network node 402, and/or retransmits the data to the network node 402 based on receiving a HARQ NACK, a HARQ process may also be downlink-based, where the network node 402 transmits data to the UE 404, waits for a HARQ ACK or HARQ NACK from the UE 404, and/or retransmits the data to the UE 404 based on receiving a HARQ NACK.

In some aspects of wireless communication, e.g., extended reality (XR) in 5G NR, some transmissions have very short periodicity and/or a tight delay condition, which may render multiple retransmissions impractical. For example, some XR flows on UL, such as pose estimation (e.g., the detection and estimation of figures or objects in an image or video), may have very short periodicity (e.g., approximately 4 ms) a and tight delay budget (e.g., approximately 10 ms), which makes it impractical to have multiple retransmissions. For such XR (or similar) flows, a UE may save power by not starting/restarting (e.g., disabling) a HARQ retransmission timer after a transmission over a configured grant (CG). For instance, a UE may implement such behavior by utilizing HARQ Mode B. However, by completely disabling the retransmissions, there may be a higher chance of a packet being decoded unsuccessfully.

In accordance with various aspects, a UE may indicate when it will early terminate a HARQ process based on a delay bound, a remaining uplink delay budget, or a packet delay budget (e.g., an upper bound for the time that a packet may be delayed between a UE and a network node). That is, a transport block may be dropped once its residual delay budget (RDB) is greater than a preconfigured or predefined threshold (e.g., a threshold defined in a wireless standard, predetermined threshold, a threshold configured by the network for the UE, a threshold preconfigured in advance of being indicated, etc.). However, when utilizing an asynchronous HARQ process, the transport block may not be dropped unless a new data indicator (NDI) is toggled. The NDI may indicate whether a transmission includes new data or whether the transmission is a retransmission of data.

In some aspects, the UE may indicate, to a network node (e.g., a gNB) the early termination of a HARQ process using uplink control information (UCI) or a medium access control (MAC)-control element (CE). Such a UCI is referred herein as UCI-HARQ Process Number Termination (UCI-HPNT). For example, the UE may indicate HARQ process(es) to be terminated for retransmission due to expiration (or impending expiration) of a traffic packet delay budget.

In some aspects, the UE may transmit the UCI-HPNT with a single field HARQ process number having a bit-width of N, where N is any positive integer (e.g., 4). The process number indicated in the UCI-HPNT may indicate a termination of a HARQ process. That is, the process number indicates the HARQ process that is to be early terminated. The expected response of the network node may be to flip (e.g., toggle) its NDI for this HARQ process. That is, the network node may set the NDI associated with the HARQ process identified by the process number to indicate that a retransmission is not to be triggered at the UE. For instance, the network node may refrain from transmitting (e.g., may not transmit), to the UE, DCI configured to schedule a retransmission of data associated with the HARQ process identified by the process number.

In some aspects, the UE may transmit the UCI-HPNT with multiple HARQ process numbers to indicate a termination of multiple HARQ processes. The process numbers indicated in the UCI-HPNT may indicate a termination of corresponding HARQ processes. That is, the process numbers indicate the HARQ processes that are to be early terminated. The expected response of the network node may be to flip (e.g., toggle) its NDI for the corresponding HARQ processes. That is, the network node may set the corresponding NDIs associated with the HARQ processes identified by the process numbers to indicate that retransmissions for these HARQ processes are not to be triggered at the UE. For instance, the network node may refrain from transmitting, to the UE, DCI configured to schedule a retransmission of data associated with the HARQ processes identified by the process numbers.

In some aspects, the UE may transmit the UCI-HPNT that includes a one-bit indication to indicate the early termination of a HARQ process based on a delay bound.

In some aspects, the UE may transmit the UCI-HPNT with a bitmap mapping to HARQ processes that are to be terminated or a time duration or a start symbol and allocation length indicator value (SLIV) that covers HARQ processes that are to be terminated.

In some aspects, if the UE sends a delay report such as delay status report or a buffer status report that includes the delay status, the UE may implicitly indicate a termination of one or more HARQ processes associated with the logical channels signalled in the delay status report.

In some aspects, the network node may provide an indication, to the UE, of a time period in which the UCI-HPNT is to be transmitted from the UE to the network node. In some aspects, the time period may correspond to a maximum time that the network node expects a HARQ process early termination indication (e.g., the UCI-HPNT) for a particular HARQ process from a UE. The time may also correspond to a minimum time utilized by the network node to process the UCI-HPNT and determine that the network node will stop the indication and/or scheduling of the HARQ process(es) corresponding to the HARQ process number(s) indicated by the UCI-HPNT. The time period may be related to a UE capability. For example, a Reduced Capability (RedCap) or an enhanced RedCap (eRedCap) UE may be able to (or not be able to) provide the indication closer to the HARQ Process that is to be terminated as an cMBB user.

In some aspects, the UCI-HPNT that identifies a first HARQ process for early termination may be transmitted on a PUSCH associated with a second HARQ process that is different than the first HARQ process, or may be transmitted on dedicated PUCCH resources (e.g., for the first HARQ process. Alternatively, the UCI-HPNT may be sent on the same PUSCH. That is, the UCI-HPNT may be sent on the PUSCH associated with the first HARQ process. This may be possible, as the UCI-HPNT and the PUSCH may be encoded with different reliabilities.

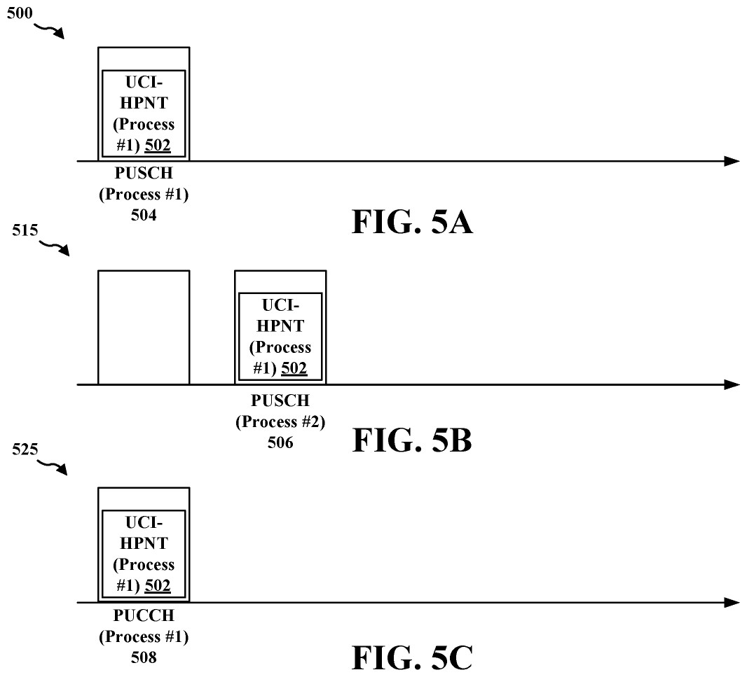

For instance, FIGS. 5A-5C illustrate diagrams 500, 515, and 525 for transmitting a UCI-HPNT in accordance with various aspects of the present disclosure. As shown in FIG. 5A, the UCI HPNT for a first HARQ process 502 (i.e., Process #1) may be transmitted on a PUSCH resource 504 associated with the first HARQ process 502. As shown in FIG. 5B, the UCI-HPNT for a first HARQ process 502 (i.e., Process #1) may be transmitted on a PUSCH resource 506 associated with a second HARQ process (i.e., Process #1). As shown in FIG. 5C, the UCI-HPNT for a first HARQ process 502 (i.e., Process #1) may be transmitted on a PUCCH resource 508 associated with the first HARQ process.

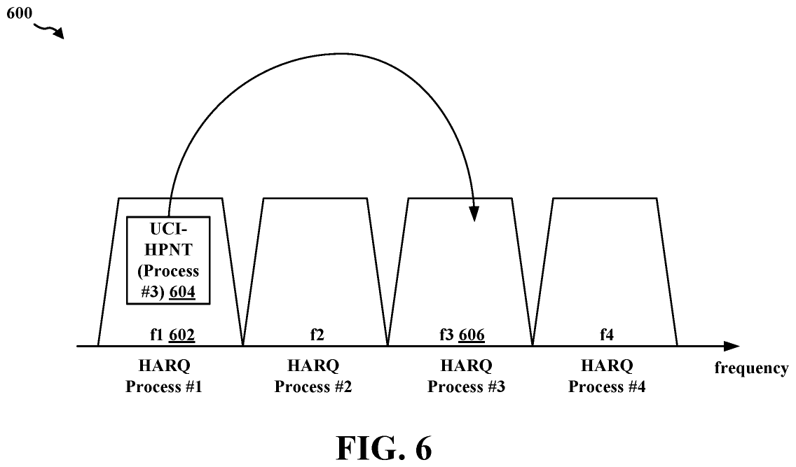

In some aspects, the UCI-HPNT may be transmitted on a first carrier and may point to a HARQ process termination on another carrier (e.g., a second carrier that is different than the first carrier). That is, the UCI-HPNT may be transmitted on a first carrier and may indicate a HARQ process number for early termination of a HARQ process on a second carrier. For example, FIG. 6 illustrates a diagram 600 for transmitting a UCI-HPNT in accordance with various aspects of the present disclosure. As shown in FIG. 6, the UCI-HPNT may be transmitted on a first carrier f1 602 and indicate a HARQ process number of a HARQ process scheduled for transmission on a different carrier. For instance, the UCI-HPNT may indicate that a HARQ process 604 (e.g., HARQ Process #3) on a second carrier f3 606 is to be early terminated.

In some aspects, the UCI-HPNT may include additional information, including, but not limited to, the survival time of a particular HARQ process from the point of view of the UE based on the remaining delay budget.

In some aspects, when a UE transmits the UCI-HPNT to indicate a termination of a HARQ process, the UE may multiplex the UCI-HPNT with a HARQ ACK or HARQ NACK associated with another HARQ process (e.g., a downlink-based HARQ process that was initiated before the HARQ process indicated via the UCI-HPNT). The UE may be configured, e.g., by the network node via RRC-based signaling, to multiplex the UCI-HPNT with the HARQ ACK or HARQ NACK. When configured for such multiplexing, in the case of a PUCCH overlapping with PUSCH(s) within a PUCCH group, the UCI-HPNT and the HARQ ACK or HARQ NACK may be jointly encoded (e.g., a high priority (HP) HARQ ACK or HARQ NACK may be jointly encoded with an HP UCI-HPNT, or a low priority (LP) HARQ ACK or HARQ NACK may be jointly encoded with an LP UCI-HPNT). When the multiplexed UCI-HPNT is transmitted in a PUSCH, the number of bits of the multiplexed UCI-HPNT and the HARQ ACK or HARQ NACK may be larger than two. In such a case, a HARQ ACK or HARQ NACK rate matching rule (or condition) may be utilized to send the multiplexed UCI-HPNT and HARQ ACK or HARQ NACK. The rate matching rule may adapt the number of bits of the multiplexed UCI-HPNT and the HARQ ACK or HARQ NACK to a number of available bits in the PUSCH. In a scenario in which the number of bits of the multiplexed UCI-HPNT and the HARQ ACK or HARQ NACK is less than two, one or more of the bits may be punctured (e.g., one or more bits (e.g., parity bits) may be removed, after encoding with an error correction code). When a UE is not configured for multiplexing and when the PUCCH overlaps with PUSCH(s) within a PUCCH group, the PUSCH may carry the HARQ ACK or HARQ NACK feedback, and the UCI-HPNT may be dropped (i.e., the UCI-HPNT may not be transmitted). In some aspects, rather than dropping the UCI-HPNT, LP CSI may be dropped, and the UCI-HPNT may be transmitted in its place.

In some aspects, the UCI-HPNT may be treated as an HP or LP UCI and may be jointly encoded with an HP or LP HARQ ACK or NACK. The corresponding multiplexed bits transmitted via a PUSCH may utilize a HARQ ACK or NACK rate matching rule condition, a puncturing rule or condition, or a resource element mapping rule or condition.

In some aspects, the UCI-HPNT may be repeated for reliability. That is, the UCI-HPNT may be transmitted more than once. The repetition(s) may occur so long as they occur within the delay bound.

In some aspects, a beta offset may be utilized for the UCI-HPNT. The beta offset may indicate whether control information (e.g., the UCI-HPNT) is to be given a relatively lower code rate. Using the beta offset, the UE may jointly encode the HARQ ACK or HARQ NACK and the UCI-HPTN and determine the number of resources for multiplexing the combined information in a PUSCH. The beta offset may have two indices for the UE to use in the event that the UE multiplexes up to X bits, and more than X combined information bits, respectively, where X is any positive integer. That is, the beta offset may have a first index or value for a multiplexed signal that includes up to X bits and may have a second index or value for a multiplexed signal that includes more than X bits. The number of bits may be a function of whether one HARQ process is indicated in the UCI-HPNT or multiple HARQ processes are indicated in the UCI-HPNT.

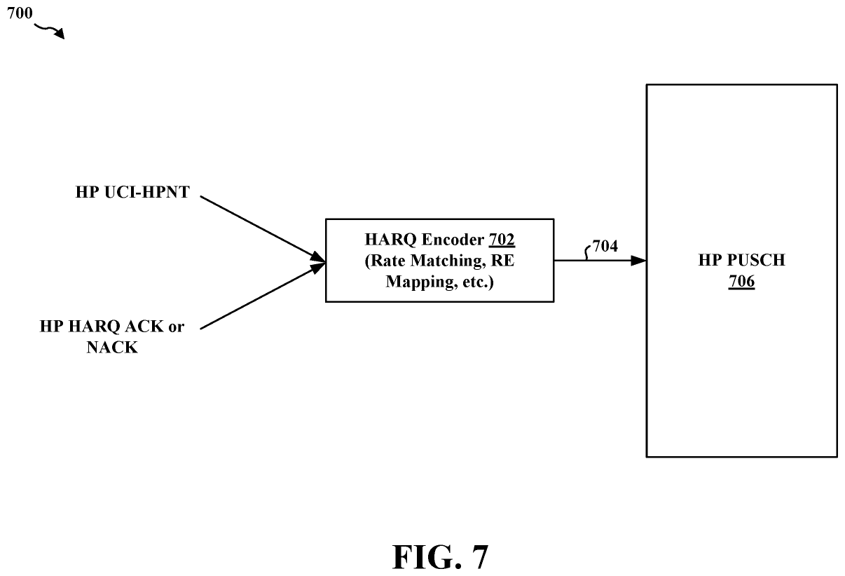

FIG. 7 is a diagram 700 illustrating the transmission of a multiplexed signal on a PUSCH in accordance with various embodiments of the present disclosure. As shown in FIG. 7, an HP UCI-HPNT and either an HP HARQ ACK or an HP HARQ NACK are provided as inputs to a HARQ encoder 702. The HARQ encoder 702 may jointly encode the UP UCI-HPNT and the HP HARQ ACK or the HP HARQ NACK utilizing a rate matching condition, puncturing, and/or a resource element mapping condition. The HARQ encoder 702 may be configured to jointly encode the UP UCI-HPNT and the HP HARQ ACK or the HP HARQ NACK utilizing bit scrambling, turbo coding, and/or forward error correction. The HARQ encoder 702 may generate and output a multiplexed signal 704 that includes one or more bits corresponding to the jointly encoded UP UCI-HPNT and the HP HARQ ACK or the HP HARQ NACK. The HARQ encoder 702 may utilize the beta offset to determine the number of resources for transmitting the multiplexed signal 704 in a PUSCH 706. It is noted that the HARQ encoder 702 may also be configured to jointly encode an LP UCI-HPNT and an LP HARQ ACK or an LP HARQ NACK in a similar fashion.

For an NR unlicensed (NR-U) configured grant PUSCH, an additional UCI (CG-UCI) may be utilized. The CG-UCI may include several fields such as a HARQ process number identifier (ID) field, an NDI field, a redundancy version (RV) field, a listen-before-talk (LBT) priority class field, a channel occupancy time (COT) duration/sharing information field, etc. The CG-UCI may allow a UE to transmit a HARQ process number ID on any configured grant resource to make it more robust to LBT-related failures. In NR, the resource for specific HARQ process IDs may not be fixed, and hence this type of UCI may not be utilized.

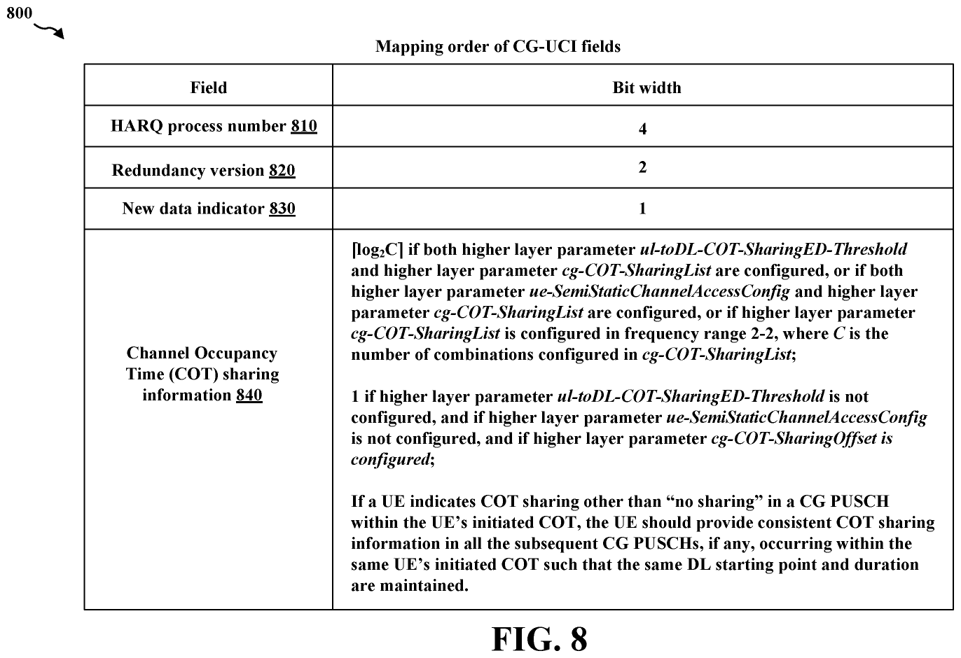

FIG. 8 is a table 800 illustrating various CG-UCI fields in accordance with various embodiments of the present disclosure. As shown in FIG. 8, the table 800 may include a HARQ process number ID field 810, which may have a bit width of 4. The table 800 may also include an RV field 820, which may have a bit width of 2. The table 800 may also include a NDI field 830, which may have a bit width of 1. The table 800 may also include a COT sharing information field 840.

In some aspects, the CG-UCI may be re-purposed to indicate the early termination of one or more HARQ processes. In this case, the HARQ process number and/or the NDI may or may not be needed. Instead of the CG-UCI indicating that the HARQ process number the UE assumes for a configured grant, the indication is for the UE terminating the HARQ process given that it exceeded a threshold or remaining uplink delay budget. That is, the HARQ process number field of the CG-UCI may indicate the HARQ process(es) that are to be terminated early. The same encoding, rate matching, beta offset values, etc., may be utilized for jointly encoding the CG-UCI with a HARQ ACK or a HARQ NACK to generate a multiplexed signal, as is used when transmitting the CG-UCI (before re-purposing).

In case the network node requests from the UE to inform it to continue or not continue a HARQ process, the NDI may be utilized. If toggled, then the network node may understand that the UE is requesting the termination of the HARQ process. If not toggled, then the network node may understand that the UE is requesting the continued transmission of the HARQ process.

In some aspects, the network node may configure, e.g., via RRC-based signaling, whether the CG-UCI is used for its initial purpose or for the purpose of indicating early termination of HARQ process(es). Alternatively, the indication may be layer 1 (L1)/layer 2 (L2) differentiated. That is, the indication may be signaled via L1 or L2 signaling. In some cases, for example, for NR-U, the CG-UCI may be utilized for its initial purpose. In such cases, the UCI-HPNT, as described above, may be utilized to indicate the early termination of HARQ process(es).

It is noted that while the aspects above describe that CG-UCI may be re-purposed, the early termination UCI may be applicable to both CG and dynamic grant (DG) transmissions. Thus, DG-UCI may also be re-purposed in a similar manner. The format of the UCI may be the same for both CG and DG transmissions.

It is also noted that CG-UCI may be transmitted with each CG-PUSCH in NR-U. Accordingly, the re-purposed CG-UCI may also be transmitted with each CG-PUSCH. Otherwise, the network node may have to blind decode for it. If that is the case, another UCI (or CG-UCI field) may be utilized to indicate the existence or a number of bits of the early termination UCI. For instance, a HARQ process number ID of all zeroes (e.g., “0000”) may indicate that there is no need to early terminate HARQ process(es).

In some aspects, a UCI indicating that certain PUSCH occasions are to be skipped may be utilized or repurposed for the purpose of indicating termination of at least the one or more HARQ process.

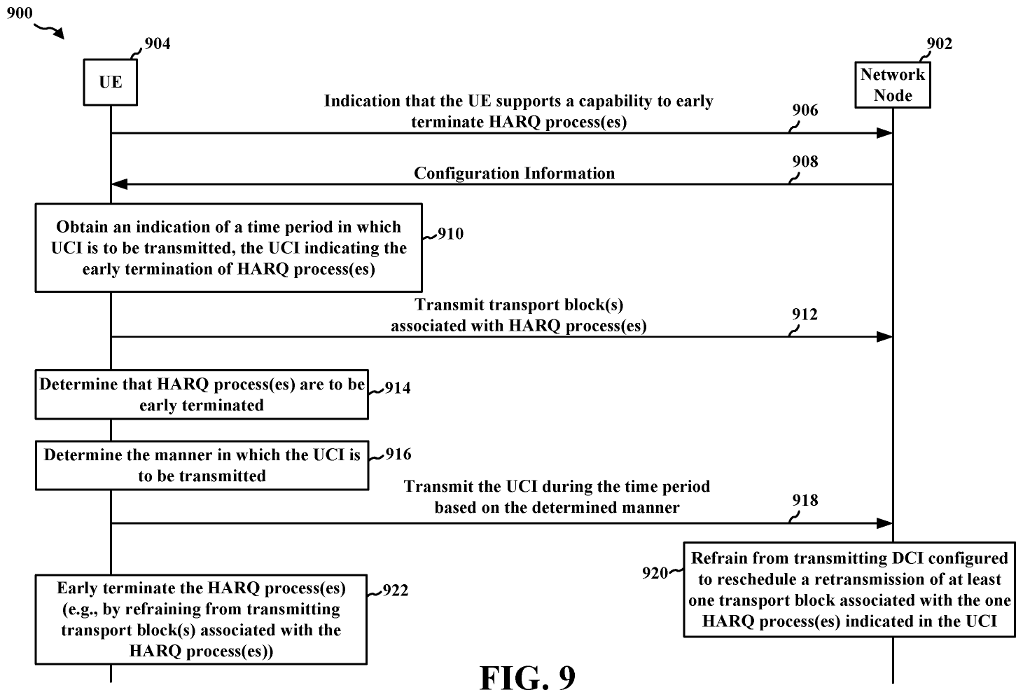

FIG. 9 is a call flow diagram 900 illustrating a method of wireless communication in accordance with various aspects of the present disclosure. As shown in FIG. 9, the call flow diagram 900 includes a network node 902 and a UE 904. The UE 904 may be an example of the UE 104, the UE 350, the UE 404. The network node 902 may be an example of the base station 102, the base station 310, or the network node 402. Although aspects are described for the network node 902, the aspects may be performed by the network node 902 in aggregation and/or by one or more components of the network node 902 (e.g., such as a CU 110, a DU 130, and/or an RU 140). As shown in FIG. 9, at 906, the UE 904 may transmit an indication, to the network node 902, that the UE 904 supports a capability to early terminate HARQ process(es).

At 908, the network node 902 may provide, to the UE 904, configuration information based on the indication received at 906. In some aspects, the configuration information may include an indication of a time period in which UCI (e.g., the UCI-HPNT) is to be transmitted, where the UCI includes bit(s) that indicate HARQ process number(s) of HARQ process(es) that are to be terminated at the UE 904. The time period may correspond to a maximum time that the network node 902 expects a HARQ process early termination indication (e.g., the UCI-HPNT) for a particular HARQ process from the UE 904. The time may also correspond to a minimum time utilized by the network node 902 to process the UCI-HPNT and determine that the network node 902 will stop the scheduling of the HARQ process(es) corresponding to the HARQ process number(s) indicated by the UCI-HPNT. In some aspects, the configuration information may include an indication that the UE 904 is to multiplex the UCI-HPNT with a HARQ ACK or HARQ NACK associated with a HARQ process that was initiated before the HARQ process(es) to be early terminated. In some aspects, the configuration information may include an indication that the UE 904 is to re-purpose CG-UCI field to indicate the HARQ process(es) that are to be early terminated.

At 910, the UE 904 may obtain an indication of a time period in which the UCI is to be transmitted. In some aspects, the UE 904 may obtain the indication based on the capability of the UE to support the early termination of HARQ process(es). For instance, the UE 904 may obtain the indication from the configuration information received at 908, which was provided by the network node 902 based on receiving the indication that the UE supports the capability to early terminate HARQ process(es). In other aspects, the UE 904 may retrieve the indication from a memory or a cache of the UE 904.

At 912, the UE 904 may initiate HARQ process(es) by transmitting medium access control (MAC) packet data unit(s) PDU(s) (e.g., transport block(s)) associated with the HARQ process(es). The MAC PDU(s) may include data from multiple logical channels and multiple IP packets. In some aspects, the network node 902 may provide HARQ NACK(s) indicating that the transport block(s) are erroneous or may provide HARQ ACK(s) indicating that the transport block(s) are valid.

At 914, the UE 904 may determine that HARQ process(es) are to be early terminated and that the UE 904 is to refrain from retransmitting the transport block(s). The UE 904 may make this determination before or after receiving HARQ NACK(s) from the network node 902. The UE 904 may determine that the HARQ process(es) are to be early terminated based on the delay bound, the remaining uplink delay budget, and/or the packet delay budget. For instance, if the such budget(s) are relatively close to expiring (or have expired), then the UE 904 may determine that that HARQ process (cs) are to be early terminated and that the UE 904 is to refrain from retransmitting the transport block(s).

At 916, the UE 904 may determine a manner in which the UCI is to be transmitted, and at 918, transmit, to the network node 902, the UCI based on the determined manner. For example, the UE 904 may, based on the configuration information received at 908, multiplex the UCI with one of a HARQ ACK or a HARQ NACK associated with a HARQ process initiated before the HARQ process(es) initiated at 912 to generate a multiplexed signal including bit(s) corresponding to the UCI and one of the HARQ ACK or the HARQ NACK.

In some aspects, the UE 904 may determine that a PUCCH associated with the HARQ process(es) to be early terminated overlap with a PUSCH within a PUCCH group associated with the HARQ process(es) to be early terminated. In such aspects, to generate the multiplexed signal, the UE 904 may jointly encode the UCI with one of the HARQ ACK or the HARQ NACK based on the determination that the PUCCH associated with the least one first HARQ process overlaps with the PUSCH within the PUCCH group.

In some aspects, the UE may determine that the multiplexed signal is to be transmitted in a PUSCH. In such aspects, at 918, the UE 904 may transmit the multiplexed signal based on a rate matching condition that adapts a number of coded bits associated with the multiplexed signal to a number of available bits in the PUSCH. In some aspects, the UE 904 may puncture at least a first bit of the bit(s) of the multiplexed signal before transmitting the multiplexed signal at 918. In some aspects, the UE 904 may determine a number of resources for transmitting the multiplexed signal in the PUSCH based on a beta offset associated with the UCI, and at 918, transmit the multiplexed signal in the PUSCH based on the number of resources.

In some aspects, the UE 904, based on the configuration information received at 908, may transmit the UCI by re-purposing CG-UCI or DG-UCI field. For instance, the bit(s) that indicate HARQ process number(s) of the HARQ process(es) to be early terminated may be specified in a field of the CG-UCI or the DG-UCI configured to store HARQ process number(s). The UE 904, at 918, may transmit the CG-UCI in a CG resource or the DG-UCI in a DG resource in lieu of the UCI-HPNT. In some aspects, the UCI may be transmitted in a PUSCH via the CG resource or the DG resource. In some aspects, the UE 904 may transmit an NDI via at least one of the CG resource or the DG resource, where the NDI, when set, may indicate that the UE 904 is requesting termination of the HARQ process(es) (e.g., identified in the CG-UCI or the DG-UCI).

In some aspects, at 918, the UE 904 may transmit the UCI a plurality of times. That is, the UE 904 may repeat the transmission of the UCI for reliability.

In some aspects, at 918, the UE 904 may transmit the UCI via a PUSCH associated with another HARQ process.

In some aspects, at 918, the UE 904 may transmit the UCI via a PUCCH associated with the HARQ process(es) to be early terminated.

In some aspects, at 918, the UE 904 may transmit the UCI via a PUSCH associated with the HARQ process(es) to be early terminated.

In some aspects, at 918, the UE 904 may transmit the UCI on a first carrier, where the HARQ process(es) to be early terminated are scheduled for transmission on a second carrier that is different than the first carrier.

At 920, based on the UCI received at 918, the network node 902 may refrain from transmitting DCI configured to reschedule a retransmission of at least one transport block (initially transmitted at 912) associated with the HARQ process(es) indicated in the UCI.

At 922, because the UE 904 does not receive the DCI, the UE 904 may early terminate the HARQ process(es) indicated in the UCI by refraining from transmitting (e.g., retransmitting) the transport block(s) associated with such HARQ process(es). That is the UE 904 may refrain from transmitting transport block(s) that include HARQ process ID(s) that are indicated in the UCI transmitted at 918.

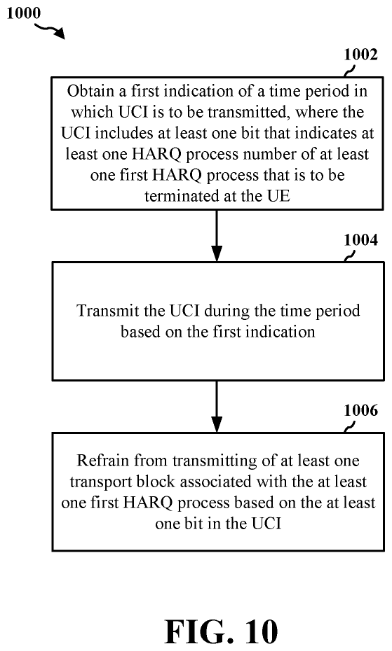

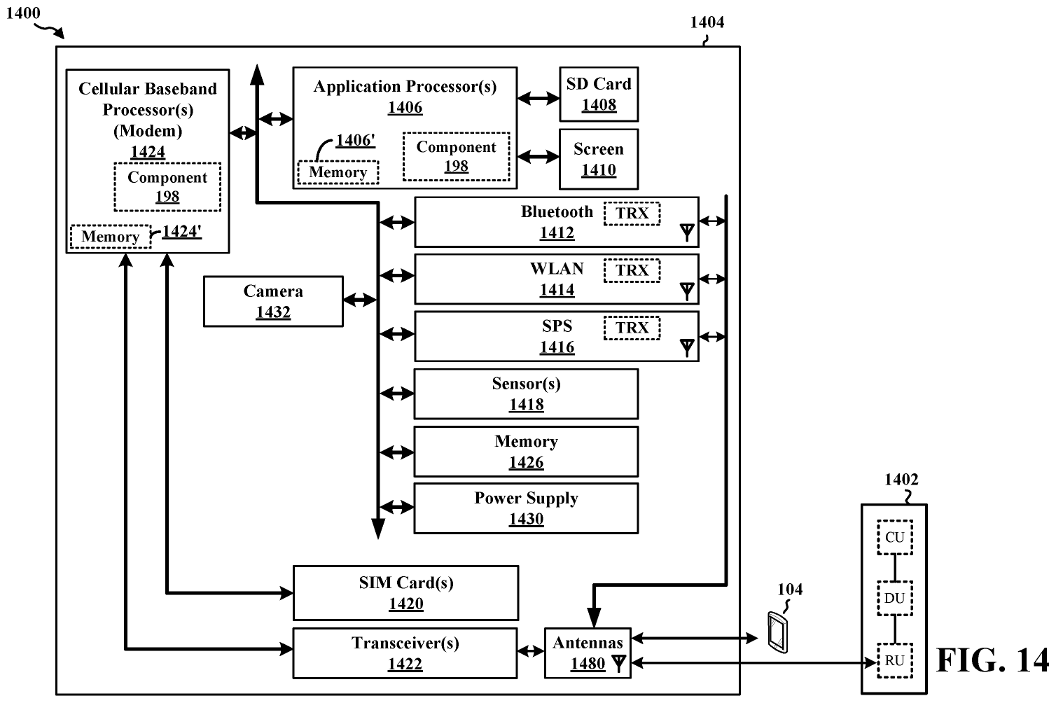

FIG. 10 is a flowchart 1000 illustrating methods of wireless communication at a UE in accordance with various aspects of the present disclosure. In some aspects, the UE may be the UE 104, the 350, the UE 404, the UE 904, or the apparatus 1404 in the hardware implementation of FIG. 14.

At 1002, the UE may obtain a first indication of a time period in which UCI is to be transmitted, where the UCI includes at least one bit that indicates at least one HARQ process number of at least one first HARQ process that is to be terminated at the UE. For example, referring to FIG. 9, the UE 904, at 910, may obtain a first indication of a time period in which UCI is to be transmitted, where the UCI includes at least one bit that indicates at least one HARQ process number of at least one first HARQ process that is to be terminated at the UE 904. In an aspect, 1002 may be performed by the HARQ process early termination component 198.

In some aspects, the UE may receive the first indication from a network node. For instance, referring to FIG. 9, the UE 904, at 908, may receive the first indication from the network node 902, for example, via the configuration information. In some aspects, the UE may obtain the first indication based on a capability of the UE to support the refraining from transmitting the at least one transport block. For example, referring to FIG. 9, the UE 904, at 910, may obtain the first indication based on a capability of the UE to support the refraining from transmitting the at least one transport block. That is, the UE 904 may obtain the indication from the configuration information received at 908, which was provided by the network node 902 based on receiving the indication that the UE supports the capability to early terminate HARQ process(es). In other aspects, the UE 904 may retrieve the indication from a memory or a cache of the UE 904.

At 1004, the UE may transmit the UCI during the time period based on the first indication. For example, referring to FIG. 9, at 918, the UE 904 may transmit the UCI during the time period based on the first indication. In an aspect, 1004 may be performed by the HARQ process early termination component 198.

At 1006, the UE may refrain from transmitting of at least one transport block associated with the at least one first HARQ process based on the at least one bit in the UCI. For example, referring to FIG. 9, at 922, the UE 904 may refrain from transmitting of at least one transport block associated with the at least one first HARQ process based on the at least one bit in the UCI. That is, the UE 904 early terminates the at least one first HARQ process. In an aspect, 1006 may be performed by the HARQ process early termination component 198.

In some aspects, the UE may transmit a second indication that the UE supports a capability to refrain from transmitting the at least one transport block, where obtaining the first indication includes obtaining the first indication based on the second indication. For example, referring to FIG. 9, at 906, the UE may transmit the second indication that the UE 904 supports the capability to refrain from transmitting the at least one transport block. The UE 904 may obtain the first indication at 910 based on the second indication. That is, the UE 904 may obtain the first indication from the configuration information received at 908, which was provided by the network node 902 based on receiving the indication that the UE supports the capability to early terminate HARQ process(es) at 906.

In some aspects, the UCI may include a plurality of bits that indicates a plurality of HARQ process numbers of a plurality of first HARQs processes that are to be terminated at the UE, where refraining from transmitting the at least one transport block includes refraining from transmitting a plurality of transport blocks associated with the plurality of first HARQ processes based on the plurality of bits. For example, referring to FIG. 9, the UCI transmitted at 918 may include a plurality of bits that indicates a plurality of HARQ process numbers of a plurality of first HARQs processes that are to be terminated at the UE 904. At 922, the UE 904 may refrain from transmitting a plurality of transport blocks associated with the plurality of first HARQ processes based on the plurality of bits.

In some aspects, the UE may transmit the UCI by transmitting the UCI via a PUSCH associated with a second HARQ process. For example, referring to FIG. 9, at 918, the UE 904 may transmit the UCI via a PUSCH associated with a second HARQ process. For instance, as shown in FIG. 5B, the UE 904, at 918, may transmit the UCI-HPNT associated with a first HARQ process 502 via a PUSCH resource 506 associated with a second process (Process #2).

In some aspects, the UE may transmit the UCI by transmitting the UCI via a PUCCH associated with the at least one first HARQ process. For example, referring to FIG. 9, at 918, the UE 904 may transmit the UCI via a PUCCH associated with the at least one HARQ process. For instance, as shown in FIG. 5C, the UE 904, at 918, may transmit the UCI-HPNT associated with a first HARQ process 502 via a PUCCH resource 508 associated with the first HARQ process 502 (Process #1).

In some aspects, the UE may transmit the UCI by transmitting the UCI via a PUSCH associated with the at least one first HARQ process. For example, referring to FIG. 9, at 918, the UE 904 may transmit the UCI via a PUSCH associated with the at least one HARQ process. For instance, as shown in FIG. 5A, the UE 904, at 918, may transmit the UCI-HPNT associated with a first HARQ process 502 via a PUSCH resource 504 associated with the first HARQ process 502 (Process #1).

In some aspects, the UE may transmit the UCI by transmitting the UCI on a first carrier, where the at least one first HARQ process is scheduled for transmission on a second carrier. For example, referring to FIG. 9, at 918, the UE 904 may transmit the UCI on a first carrier, where the at least one first HARQ process is scheduled for transmission on a second carrier. For instance, as shown in FIG. 6, the UE 904, at 918, may transmit the UCI-HPNT on a first carrier f1 602 and indicate a HARQ process number of a HARQ process scheduled for transmission a different carrier. For instance, the UCI-HPNT may indicate that a HARQ process 604 (e.g., HARQ Process #3) on a second carrier f3 606 is to be early terminated.

In some aspects, the UE may receive a second indication that the UE is to multiplex the UCI with one of a HARQ ACK or a HARQ NACK associated with a second HARQ process, and may multiplex the UCI with one of the HARQ ACK or the HARQ NACK based on the second indication in order to generate a multiplexed signal including one or more bits, where the UE transmits the UCI by transmitting the multiplexed signal. For example, referring to FIG. 9, at 908, the UE may receive a second indication, via the configuration information, that the UE 904 is to multiplex the UCI with one of a HARQ ACK or a HARQ NACK associated with a second HARQ process. The second HARQ process may be initiated before the HARQ process(es) at 912 were initiated. At 916, the UE 904 may multiplex the UCI with one of the HARQ ACK or the HARQ NACK based on the second indication in order to generate a multiplexed signal including one or more bits. At 918, the UE 904 may transmit the multiplexed signal. In another example, referring to FIG. 7, the HARQ encoder 702, which may be included in the UE 904, may multiplex the UCI with one of the HARQ ACK or the HARQ NACK based on the second indication in order to generate the multiplexed signal 704 including one or more bits corresponding to the UCI and one of the HARQ ACK or the HARQ NACK.

In some aspects, the UE may multiplex the UCI with one of the HARQ ACK or the HARQ NACK by determining that a PUCCH associated with the at least one first HARQ process overlaps with a PUSCH within a PUCCH group associated with the at least one first HARQ process, and jointly encoding the UCI with one of the HARQ ACK or the HARQ NACK based on the determination that the PUCCH associated with the least one first HARQ process overlaps with the PUSCH within the PUCCH group. For example, referring to FIG. 9, at 916, the UE 904 may determine that a PUCCH associated with the at least one first HARQ process overlaps with a PUSCH within a PUCCH group associated with the at least one first HARQ process, and jointly encode the UCI with one of the HARQ ACK or the HARQ NACK based on the determination that the PUCCH associated with the least one first HARQ process overlaps with the PUSCH within the PUCCH group. In another example, referring to FIG. 7, the HARQ encoder 702 may determine that a PUCCH associated with the at least one first HARQ process overlaps with the PUSCH 706 within a PUCCH group associated with the at least one first HARQ process, and jointly encode the UCI with one of the HARQ ACK or the HARQ NACK based on the determination that the PUCCH associated with the least one first HARQ process overlaps with the PUSCH 706 within the PUCCH group.

In some aspects, the UE may transmit the multiplexed signal by determining that the multiplexed signal is to be transmitted in a PUSCH, and transmitting, based on the determination that the multiplexed signal is to be transmitted in the PUSCH, the multiplexed signal based on a rate matching condition that adapts a number of coded bits associated with the multiplexed signal to a number of available bits in the PUSCH. For example, referring to FIG. 9, at 916, the UE 904 may determine that the multiplexed signal is to be transmitted in a PUSCH. At 918, the UE 904 may transmit, based on the determination that the multiplexed signal is to be transmitted in the PUSCH, the multiplexed signal based on a rate matching condition that adapts a number of coded bits associated with the multiplexed signal to a number of available bits in the PUSCH. In another example, referring to FIG. 7, the HARQ encoder 702 may determine that the multiplexed signal 704 is to be transmitted in the PUSCH 706. At 918, the HARQ encoder 702 may transmit, based on the determination that the multiplexed signal 704 is to be transmitted in the PUSCH 706, the multiplexed signal based on a rate matching condition that adapts a number of coded bits associated with the multiplexed signal 704 to a number of available bits in the PUSCH 706.

In some aspects, the UE may puncture at least one first bit of the one or more bits of the multiplexed signal. For example, referring to FIG. 9, the UE 904 may puncture at least one first bit of the one or more bits of the multiplexed signal before transmitting the multiplexed signal at 918. In some aspects, referring to FIG. 7, the HARQ encoder 702 punctures the at least one first bit of the one or more bits of the multiplexed signal 704.

In some aspects, the UE may determine that the multiplexed signal is to be transmitted in the PUSCH by determining a number of resources for transmitting the multiplexed signal in the PUSCH based on a beta offset associated with the UCI, and transmitting the multiplexed signal in the PUSCH based on the number of resources. For example, referring to FIG. 9, at 916, the UE 904 may determine that the multiplexed signal is to be transmitted in the PUSCH by determining a number of resources for transmitting the multiplexed signal in the PUSCH based on a beta offset associated with the UCI. At 918, the UE 904 may transmit the multiplexed signal in the PUSCH based on the number of resources. In another example, referring to FIG. 7, the HARQ encoder 702 may determine a number of resources for transmitting the multiplexed signal 704 in the PUSCH 706 based on a beta offset associated with the UCI, and transmit the multiplexed signal 704 in the PUSCH 706 based on the number of resources.

In some aspects, the at least one bit may be specified in a field configured to store the at least one HARQ process number, where the field is included in at least one of a CG resource or a DG resource. In such aspects, the UE may transmit the UCI by transmitting the UCI via at least one of the CG resource or the DG resource. For example, referring to FIG. 8, the at least one bit may be specified in a HARQ process number field of a CG-UCI (or a DG-UCI). The HARQ process number field may be configured to store the at least one HARQ process number, where the field is included in at least one of a CG resource (e.g., the CG-UCI) or a DG resource (e.g., the DG-UCI). Referring to FIG. 9, at 918, the UE 904 may transmit the UCI via at least one of the CG resource or the DG resource.

In some aspects, the UE may transmit an NDI via at least one of the CG resource or the DG resource, where the NDI, when set, indicates that the UE is requesting termination of the at least one first HARQ process. For example, referring to FIG. 9, the UE 904, at 918, may transmit an NDI via at least one of the CG resource or the DG resource, where the NDI, when set, indicates that the UE is requesting termination of the at least one first HARQ process. Referring to FIG. 8, the NDI may be specified in the NDI field of the CG-UCI (or a DG-UCI). The UE 904 may transmit the CG-UCI or the DG-UCI specifying the NDI at 918.

In some aspects, the UE may receive a second indication that configures the UE to utilize the field to specify the at least one bit. For example, referring to FIG. 9, at 908, the UE 904 may receive a second indication, via the configuration information, that configures the UE 904 to utilize the field to specify the at least one bit (e.g., the configuration information received at 906 may indicate that the UE 904 is to re-purpose the CG-UCI (or DG-UCI) to indicate the early termination of HARQ process(es)).

In some aspects, the UE may transmit the UCI a plurality of times. For example, referring to FIG. 9, at 918, the UE 904 may transmit the UCI a plurality of times. That is, the UE 904 may repeat the transmission of the UCI for reliability.

In some aspects, the UE may transmit the UCI in a PUSCH via at least one of the CG resource or the DG resource. For example, referring to FIG. 9, at 918, the UE 904 may transmit the UCI in a PUSCH via at least one of the CG resource or the DG resource.

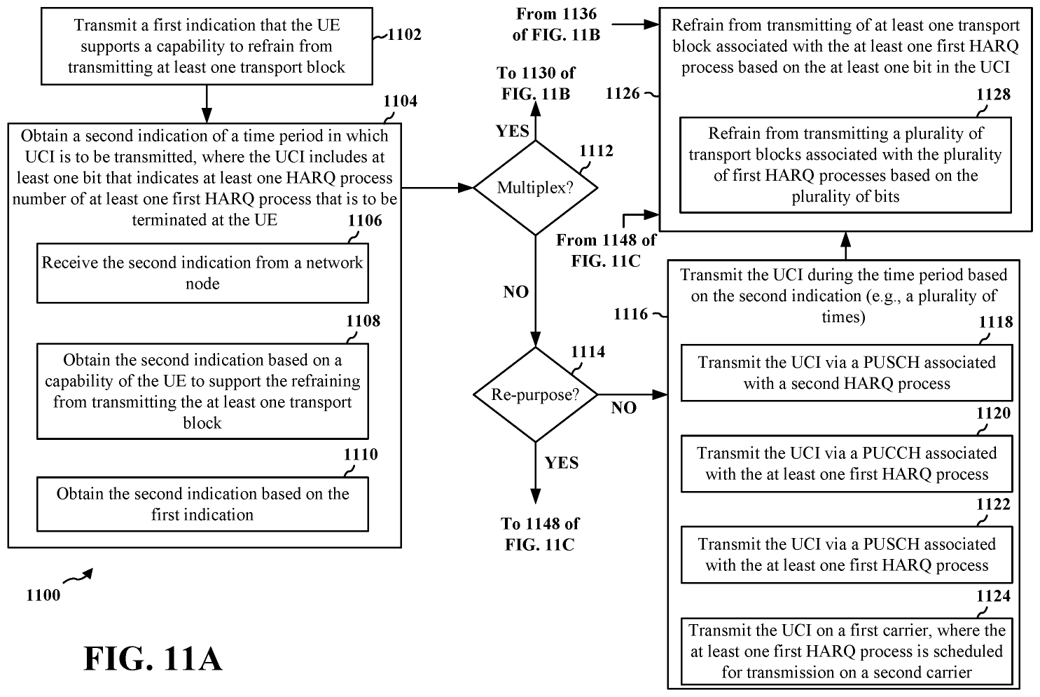

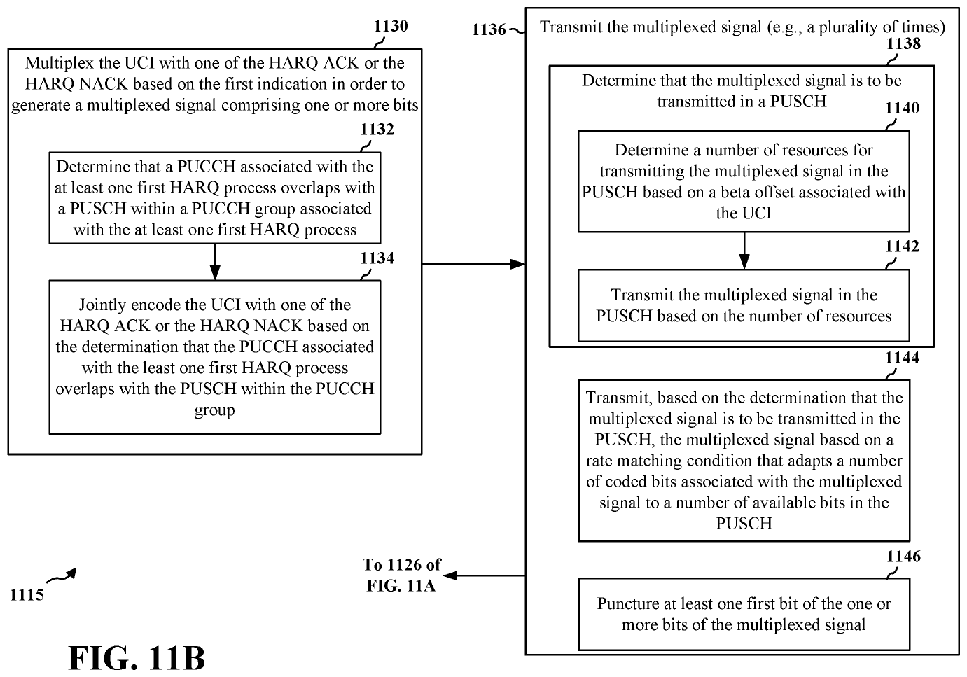

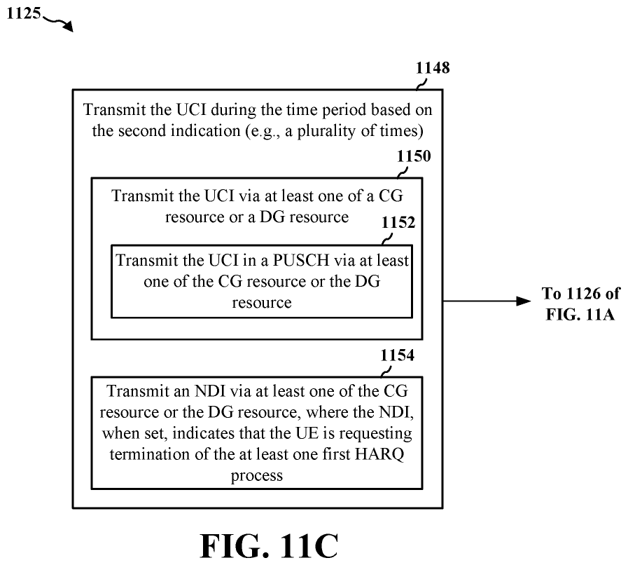

FIGS. 11A-11C are flowcharts 1100, 1115, and 1125 illustrating methods of wireless communication at a UE in accordance with various aspects of the present disclosure. In some aspects, the UE may be the UE 104, the 350, the UE 404, the UE 904, or the apparatus 1404 in the hardware implementation of FIG. 14.

As shown in FIG. 11A, at 1102, the UE may transmit a first indication that the UE supports a capability to refrain from transmitting at least one transport block. For example, referring to FIG. 9, at 906, the UE may transmit the indication that the UE 904 supports the capability to refrain from transmitting the at least one transport block. In an aspect, 1102 may be performed by the HARQ process early termination component 198.

At 1104, the UE may obtain a second indication of a time period in which UCI is to be transmitted, where the UCI includes at least one bit that indicates at least one HARQ process number of at least one first HARQ process that is to be terminated at the UE. For example, referring to FIG. 9, the UE 904, at 910, may obtain an indication of a time period in which UCI is to be transmitted, where the UCI includes at least one bit that indicates at least one HARQ process number of at least one first HARQ process that is to be terminated at the UE 904. In an aspect, 1104 may be performed by the HARQ process early termination component 198.

In some aspects, as part of 1104, at 1106, the UE may receive the second indication from a network node. For instance, referring to FIG. 9, the UE 904, at 908, may receive the indication from the network node 902, for example, via the configuration information. In an aspect, 1106 may be performed by the HARQ process early termination component 198.

In some aspects, as part of 1104, at 1108, the UE may obtain the second indication based on a capability of the UE to support refraining from transmitting the at least one transport block. For example, referring to FIG. 9, the UE 904, at 910, may obtain the indication based on a capability of the UE to support the refraining from transmitting the at least one transport block. That is, the UE 904 may obtain the indication from the configuration information received at 908, which was provided by the network node 902 based on receiving the indication that the UE supports the capability to early terminate HARQ process(es). In an aspect, 1108 may be performed by the HARQ process early termination component 198.

In some aspects, as part of 1104, at 1110, the UE may obtain the second indication based on the first indication. For example, referring to FIG. 9, the UE 904 may obtain the second indication at 910 based on the first indication. That is, the UE 904 may obtain the second indication from the configuration information received at 908, which was provided by the network node 902 based on receiving the first indication that the UE supports the capability to early terminate HARQ process(es) at 906. In an aspect, 1110 may be performed by the HARQ process early termination component 198.

At 1112, the UE may determine whether it is to multiplex the UCI with one of a HARQ ACK or a HARQ NACK of a second HARQ process (e.g., a downlink-based HARQ process that was initiated before the HARQ process to be early terminated). If the UE receives such an indication, flow continues to 1130 of FIG. 11B. Otherwise, flow may continue to 1114. For instance, the UE may receive an indication that the UE is to multiplex the UCI with one of a HARQ ACK or a HARQ NACK associated with the second HARQ process. For example, referring to FIG. 9, at 908, the UE may receive a second indication, via the configuration information, that the UE 904 is to multiplex the UCI with one of a HARQ ACK or a HARQ NACK associated with a second HARQ process. The second HARQ process may be initiated before the HARQ process(es) at 912 were initiated. In an aspect. 1112 may be performed by the HARQ process early termination component 198.

At 1114, the UE may determine whether it is to re-purpose a field of the CG-UCI or the DG-UCI to indicate HARQ process(es) to be early terminated. For instance, the UE may receive an indication that configures the UE to utilize the field to specify the at least one bit corresponding to the HARQ process number of the HARQ process to be early terminated. In such an aspect, the at least one bit may be specified in a field configured to store the at least one HARQ process number, where the field is included in at least one of a CG resource (e.g., the CG-UCI) or a DG resource (e.g., the DG-UCI). If the UE receives such an indication, flow continues to 1148 of FIG. 11C. Otherwise, flow continues to 1116. For example, referring to FIG. 9, at 908, the UE 904 may receive an indication, via the configuration information, that configures the UE 904 to utilize the field to specify the at least one bit (e.g., the configuration information received at 906 may indicate that the UE 904 is to re-purpose the CG-UCI (or DG-UCI) to indicate the early termination of HARQ process(es)). In an aspect, 1114 may be performed by the HARQ process early termination component 198.

At 1116, the UE may transmit the UCI during the time period based on the second indication. For example, referring to FIG. 9, at 918, the UE 904 may transmit the UCI during the time period based on the second indication. In some aspects, the UE may transmit the UCI a plurality of times. For example, referring to FIG. 9, at 918, the UE 904 may transmit the UCI a plurality of times. That is, the UE 904 may repeat the transmission of the UCI for reliability. In an aspect, 1116 may be performed by the HARQ process early termination component 198.

In some aspects, as part of 1116, at 1118, the UE may transmit the UCI via a PUSCH associated with a second HARQ process. For example, referring to FIG. 9, at 918, the UE 904 may transmit the UCI via a PUSCH associated with a second HARQ process. For instance, as shown in FIG. 5B, the UE 904, at 918, may transmit the UCI-HPNT associated with a first HARQ process 502 via a PUSCH resource 506 associated with a second process (Process #2). In an aspect, 1118 may be performed by the HARQ process early termination component 198.

In some aspects, as part of 1116, at 1120, the UE may transmit the UCI via a PUCCH associated with the at least one first HARQ process. For example, referring to FIG. 9, at 918, the UE may transmit the UCI via a PUCCH associated with the at least one HARQ process. For instance, as shown in FIG. 5C, the UE 904, at 918, may transmit the UCI-HPNT associated with a first HARQ process 502 via a PUCCH resource 508 associated with the first HARQ process 502 (Process #1). In an aspect, 1120 may be performed by the HARQ process early termination component 198.

In some aspects, as part of 1116, at 1122, the UE may transmit the UCI via a PUSCH associated with the at least one first HARQ process. For example, referring to FIG. 9, at 918, the UE may transmit the UCI via a PUSCH associated with the at least one HARQ process. For instance, as shown in FIG. 5A, the UE 904, at 918, may transmit the UCI-HPNT associated with a first HARQ process 502 via a PUSCH resource 504 associated with the first HARQ process 502 (Process #1). In an aspect, 1122 may be performed by the HARQ process early termination component 198.

In some aspects, as part of 1116, at 1124, the UE may transmit the UCI on a first carrier, where the at least one first HARQ process is scheduled for transmission on a second carrier. For example, referring to FIG. 9, at 918, the UE may transmit the UCI on a first carrier, where the at least one first HARQ process is scheduled for transmission on a second carrier. For instance, as shown in FIG. 6, the UE 904, at 918, may transmit the UCI-HPNT on a first carrier f1 602 and indicate a HARQ process number of a HARQ process scheduled for transmission a different carrier. For instance, the UCI-HPNT may indicate that a HARQ process 604 (e.g., HARQ Process #3) on a second carrier f3 606 is to be early terminated. In an aspect, 1124 may be performed by the HARQ process early termination component 198.

At 1126, the UE may refrain from transmitting of at least one transport block associated with the at least one first HARQ process based on the at least one bit in the UCI. For example, referring to FIG. 9, at 922, the UE 904 may refrain from transmitting of at least one transport block associated with the at least one first HARQ process based on the at least one bit in the UCI. That is, the UE 904 early terminates the at least one first HARQ process. In an aspect, 1126 may be performed by the HARQ process early termination component 198.

In some aspects, the UCI may include a plurality of bits that indicates a plurality of HARQ process numbers of a plurality of first HARQs processes that are to be terminated at the UE. In such aspects, as part of 1126, at 1128, the UE may refrain from transmitting a plurality of transport blocks associated with the plurality of first HARQ processes based on the plurality of bits. For example, referring to FIG. 9, the UCI transmitted at 918 may include a plurality of bits that indicates a plurality of HARQ process numbers of a plurality of first HARQs processes that are to be terminated at the UE 904. At 922, the UE 904 may refrain from transmitting a plurality of transport blocks associated with the plurality of first HARQ processes based on the plurality of bits. In an aspect, 1128 may be performed by the HARQ process early termination component 198.

Referring to flowchart 1115 of FIG. 11B, at 1130, the UE may multiplex the UCI with one of the HARQ ACK or the HARQ NACK based on the first indication in order to generate a multiplexed signal including one or more bits. For example, referring to FIG. 9, at 916, the UE 904 may multiplex the UCI with one of the HARQ ACK or the HARQ NACK based on the first indication in order to generate a multiplexed signal including one or more bits. In another example, referring to FIG. 7, the HARQ encoder 702, which may be included in the UE 904, may multiplex the UCI with one of the HARQ ACK or the HARQ NACK based on the second indication in order to generate the multiplexed signal 704 including one or more bits corresponding to the UCI and one of the HARQ ACK or the HARQ NACK. In an aspect, 1130 may be performed by the HARQ process early termination component 198.

In some aspects, as part of 1130, at 1132, the UE may multiplex the UCI with one of the HARQ ACK or the HARQ NACK by determining that a PUCCH associated with the at least one first HARQ process overlaps with a PUSCH within a PUCCH group associated with the at least one first HARQ process. For example, referring to FIG. 9, at 916, the UE 904 may determine that a PUCCH associated with the at least one first

HARQ process overlaps with a PUSCH within a PUCCH group associated with the at least one first HARQ process. In another example, referring to FIG. 7, the HARQ encoder 702 may determine that a PUCCH associated with the at least one first HARQ process overlaps with the PUSCH 706 within a PUCCH group associated with the at least one first HARQ process. In an aspect, 1132 may be performed by the HARQ process early termination component 198.

In some aspects, as part of 1130, at 1134, the UE may jointly encode the UCI with one of the HARQ ACK or the HARQ NACK based on the determination that the PUCCH associated with the least one first HARQ process overlaps with the PUSCH within the PUCCH group. For example, referring to FIG. 9, at 916, the UE 904 may jointly encode the UCI with one of the HARQ ACK or the HARQ NACK based on the determination that the PUCCH associated with the least one first HARQ process overlaps with the PUSCH within the PUCCH group. In another example, referring to FIG. 7, the HARQ encoder 702 may jointly encode the UCI with one of the HARQ ACK or the HARQ NACK based on the determination that the PUCCH associated with the least one first HARQ process overlaps with the PUSCH 706 within the PUCCH group. In an aspect, 1134 may be performed by the HARQ process early termination component 198.

At 1136, the UE may transmit the multiplexed signal. For example, referring to FIG. 9, the UE 904, at 918, may transmit the multiplexed signal. In some aspects, the UE may transmit the UCI (via the multiplexed signal) a plurality of times. For example, referring to FIG. 9, at 918, the UE 904 may transmit the UCI a plurality of times. That is, the UE 904 may repeat the transmission of the UCI for reliability. In an aspect, 1136 may be performed by the HARQ process early termination component 198.

In some aspects, as part of 1136, at 1138, the UE may transmit the multiplexed signal by determining that the multiplexed signal is to be transmitted in a PUSCH. For example, referring to FIG. 9, at 916, UE 904 may determine that the multiplexed signal is to be transmitted in a PUSCH. In another example, referring to FIG. 7, the HARQ encoder 702 may determine that the multiplexed signal 704 is to be transmitted in the PUSCH 706. In an aspect, 1138 may be performed by the HARQ process early termination component 198.

In some aspects, as part of 1138, at 1140, the UE may determine that the multiplexed signal is to be transmitted in the PUSCH by determining a number of resources for transmitting the multiplexed signal in the PUSCH based on a beta offset associated with the UCI. For example, referring to FIG. 9, at 916, the UE 904 may determine that the multiplexed signal is to be transmitted in the PUSCH by determining a number of resources for transmitting the multiplexed signal in the PUSCH based on a beta offset associated with the UCI. In another example, referring to FIG. 7, the HARQ encoder 702 may determine a number of resources for transmitting the multiplexed signal 704 in the PUSCH 706 based on a beta offset associated with the UCI. In an aspect, 1140 may be performed by the HARQ process early termination component 198.

In some aspects, as part of 1138, at 1142, the UE may transmit the multiplexed signal in the PUSCH based on the number of resources. For example, referring to FIG. 9, at 918, the UE 904 may transmit the multiplexed signal in the PUSCH based on the number of resources. In another example, referring to FIG. 7, the HARQ encoder 702 may transmit the multiplexed signal 704 in the PUSCH 706 based on the number of resources. In an aspect, 1142 may be performed by the HARQ process early termination component 198.

In some aspects, as part of 1136, at 1144, the UE may transmit, based on the determination that the multiplexed signal is to be transmitted in the PUSCH, the multiplexed signal based on a rate matching condition that adapts a number of coded bits associated with the multiplexed signal to a number of available bits in the PUSCH. For example, referring to FIG. 9, at 918, the UE 904 may transmit, based on the determination that the multiplexed signal is to be transmitted in the PUSCH, the multiplexed signal based on a rate matching condition that adapts a number of coded bits associated with the multiplexed signal to a number of available bits in the PUSCH. In another example, referring to FIG. 7, the HARQ encoder 702 may transmit, based on the determination that the multiplexed signal 704 is to be transmitted in the PUSCH 706, the multiplexed signal based on a rate matching condition that adapts a number of coded bits associated with the multiplexed signal 704 to a number of available bits in the PUSCH 706. In an aspect, 1144 may be performed by the HARQ process early termination component 198.

In some aspects, as part of 1136, at 1146, the UE may puncture at least one first bit of the one or more bits of the multiplexed signal. For example, referring to FIG. 9, the UE 904 may puncture at least one first bit of the one or more bits of the multiplexed signal before transmitting the multiplexed signal at 918. In some aspects, referring to FIG. 7, the HARQ encoder 702 punctures the at least one first bit of the one or more bits of the multiplexed signal 704. In an aspect, 1146 may be performed by the HARQ process early termination component 198.

Referring to the flowchart 1125 of FIG. 11C, at 1148, the UE may transmit the UCI during the time period based on the second indication. For example, referring to FIG. 9, at 918, the UE 904 may transmit the UCI during the time period based on the second indication. In some aspects, the UE may transmit the UCI a plurality of times. For example, referring to FIG. 9, at 918, the UE 904 may transmit the UCI a plurality of times. That is, the UE 904 may repeat the transmission of the UCI for reliability. In an aspect, 1148 may be performed by the HARQ process early termination component 198.

In some aspects, as part of 1148, at 1150, the UE may transmit the UCI by transmitting the UCI via at least one of the CG resource or the DG resource. For example, referring to FIG. 8, the at least one bit may be specified in a HARQ process number field of a CG-UCI (or a DG-UCI). The HARQ process number field may be configured to store the at least one HARQ process number, where the field is included in at least one of a CG resource (e.g., the CG-UCI) or a DG resource (e.g., the DG-UCI). Referring to FIG. 9, at 918, the UE 904 may transmit the UCI via at least one of the CG resource or the DG resource. In an aspect, 1150 may be performed by the HARQ process early termination component 198.

In some aspects, as part of 1150, at 1152, the UE may transmit the UCI in a PUSCH via at least one of the CG resource or the DG resource. For example, referring to FIG. 9, at 918, the UE 904 may transmit the UCI in a PUSCH via at least one of the CG resource or the DG resource. In an aspect, 1152 may be performed by the HARQ process early termination component 198.

In some aspects, as part of 1148, at 1154, UE may transmit an NDI via at least one of the CG resource or the DG resource, where the NDI, when set, indicates that the UE is requesting termination of the at least one first HARQ process. For example, referring to FIG. 9, the UE 904, at 918, may transmit an NDI via at least one of the CG resource or the DG resource, where the NDI, when set, indicates that the UE is requesting termination of the at least one first HARQ process. Referring to FIG. 8, the NDI may be specified in the NDI field of the CG-UCI (or a DG-UCI). The UE 904 may transmit the CG-UCI or the DG-UCI specifying the NDI at 918. In an aspect, 1154 may be performed by the HARQ process early termination component 198.

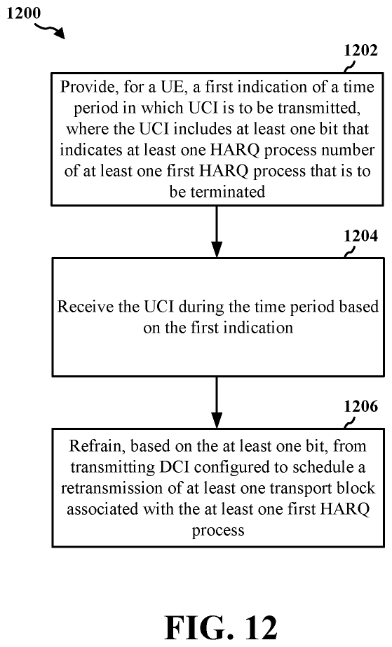

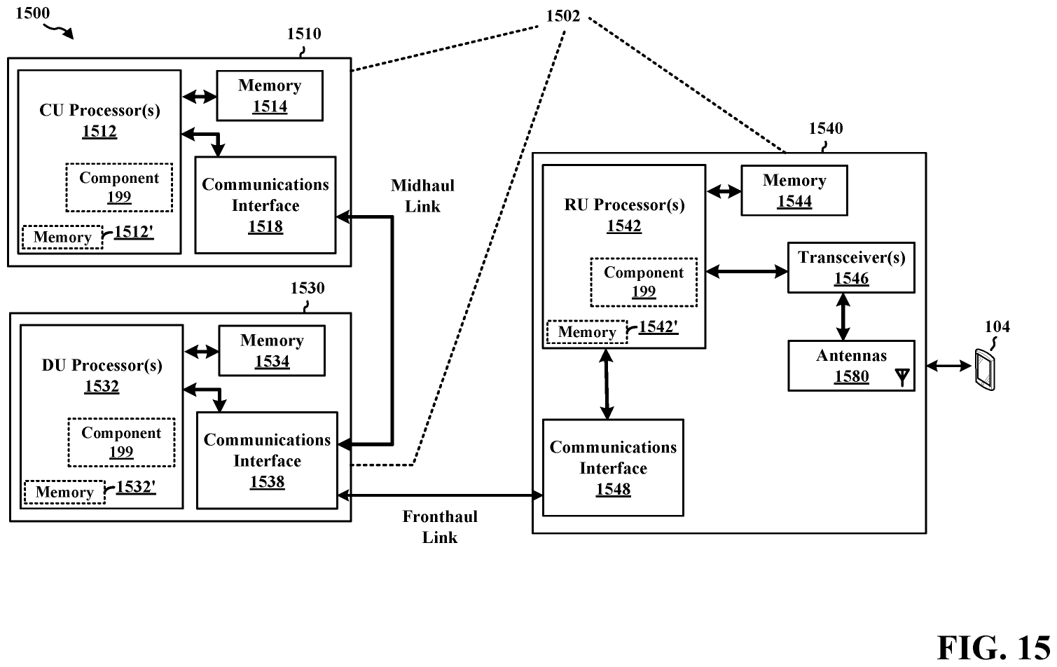

FIG. 12 is a flowchart 1200 illustrating methods of wireless communication at a network node in accordance with various aspects of the present disclosure. In some aspects, the network node may be the base station 102, the base station 310, the network node 402, the network node 902, or the network entity 1502 in the hardware implementation of FIG. 15.

At 1202, the network node may provide, for a UE, a first indication of a time period in which UCI is to be transmitted, where the UCI includes at least one bit that indicates at least one HARQ process number of at least one first HARQ process that is to be terminated. For example, referring to FIG. 9, the network node 902, at 908 may provide, for the UE 904, configuration information that includes a first indication of a time period in which UCI is to be transmitted, where the UCI includes at least one bit that indicates at least one HARQ process number of at least one first HARQ process that is to be terminated. In an aspect, 1202 may be performed by the HARQ process early termination component 199.

At 1204, the network node may receive the UCI during the time period based on the first indication. For example, referring to FIG. 9, the network node 902, at 918, may receive the UCI during the time period based on the first indication. In an aspect, 1204 may be performed by the HARQ process early termination component 199.

At 1206, the network node may refrain, based on the at least one bit, from transmitting DCI configured to schedule a retransmission of at least one transport block associated with the at least one first HARQ process. For example, referring to FIG. 9, the network node 902, at 920, may refrain, based on the at least one bit, from transmitting DCI configured to schedule a retransmission of at least one transport block associated with the at least one first HARQ process.

In some aspects, the network node may receive, from the UE, a second indication that the UE supports a capability to refrain from transmitting the retransmission of the at least one transport block. The network node may provide, for the UE, the first indication based on the second indication. For example, referring to FIG. 9, the network node 902, at 906, may receive, from the UE 904, a second indication that the UE 904 supports a capability to refrain from transmitting the retransmission of the at least one transport block. The network node 902 may provide, for the UE 904, the first indication based on the second indication.

In some aspects, the UCI may include a plurality of bits that indicates a plurality of HARQ process numbers of a plurality of first HARQs processes that are to be terminated. The network node may refrain from transmitting the DCI by refraining, based on the plurality of bits, from transmitting the DCI, where the DCI is configured to schedule the retransmission of a plurality of transport blocks associated with the plurality of HARQ process numbers. For example, referring to FIG. 9, the UCI received at 918 may include a plurality of bits that indicates a plurality of HARQ process numbers of a plurality of first HARQs processes that are to be terminated. At 920, the network node may refrain from transmitting the DCI to the UE 904 by refraining, based on the plurality of bits, from transmitting the DCI, where the DCI is configured to schedule the retransmission of a plurality of transport blocks associated with the plurality of HARQ process numbers.

In some aspects, the network node may receive the UCI by receiving the UCI via a PUSCH associated with a second HARQ process. For example, referring to FIG. 9, at 918, the network node 902 may receive the UCI via a PUSCH associated with a second HARQ process. For instance, as shown in FIG. 5B, the network node 902, at 918, may receive the UCI-HPNT associated with a first HARQ process 502 via a PUSCH resource 506 associated with a second process (Process #2).

In some aspects, the network node may receive the UCI by receiving the UCI via a PUCCH associated with the at least one first HARQ process. For example, referring to FIG. 9, at 918, the network node 902 may receive the UCI via a PUCCH associated with the at least one HARQ process. For instance, as shown in FIG. 5C, the network node 902, at 918, may receive the UCI-HPNT associated with a first HARQ process 502 via a PUCCH resource 508 associated with the first HARQ process 502 (Process #1).

In some aspects, the network node may receive the UCI by receiving the UCI via a PUSCH associated with the at least one first HARQ process. For example, referring to FIG. 9, at 918, the network node 902 may receive the UCI via a PUSCH associated with the at least one HARQ process. For instance, as shown in FIG. 5A, the network node 902, at 918, may receive the UCI-HPNT associated with a first HARQ process 502 via a PUSCH resource 504 associated with the first HARQ process 502 (Process #1).

In some aspects, the network node may receive the UCI on a first carrier, where the at least one first HARQ process is scheduled for transmission on a second carrier. For example, referring to FIG. 9, at 918, the network node 902 may receive the UCI on a first carrier, where the at least one first HARQ process is scheduled for transmission on a second carrier. For instance, as shown in FIG. 6, the network node 902, at 918, may receive the UCI-HPNT on a first carrier f1 602 and indicate a HARQ process number of a HARQ process scheduled for transmission a different carrier. For instance, the UCI-HPNT may indicate that a HARQ process 604 (e.g., HARQ Process #3) on a second carrier f3 606 is to be early terminated.

In some aspects, the network node may transmit, for the UE, a second indication that the UE is to multiplex the UCI with one of a HARQ ACK or a HARQ NACK associated with a second HARQ process. For example, referring to FIG. 9, at 908, the network node 902 may transmit, to the UE 904, configuration information that includes an indication that the UE 904 is to multiplex the UCI with one of a HARQ ACK or a HARQ NACK associated with a second HARQ process (e.g., a downlink-based HARQ process that was initiated before the HARQ process initiated at 912).

In some aspects, the at least one bit may be specified in a field configured to store the at least one HARQ process number, where the field is included in at least one of a CG resource or a DG resource. In such aspects, the network node may receive the UCI via at least one of the CG resource or the DG resource. For example, referring to FIG. 8, the at least one bit may be specified in a HARQ process number field of a CG-UCI (or a DG-UCI). The HARQ process number field may be configured to store the at least one HARQ process number, where the field is included in at least one of a CG resource (e.g., the CG-UCI) or a DG resource (e.g., the DG-UCI). Referring to FIG. 9, at 918, the network node 902 may receive the UCI via at least one of the CG resource or the DG resource.

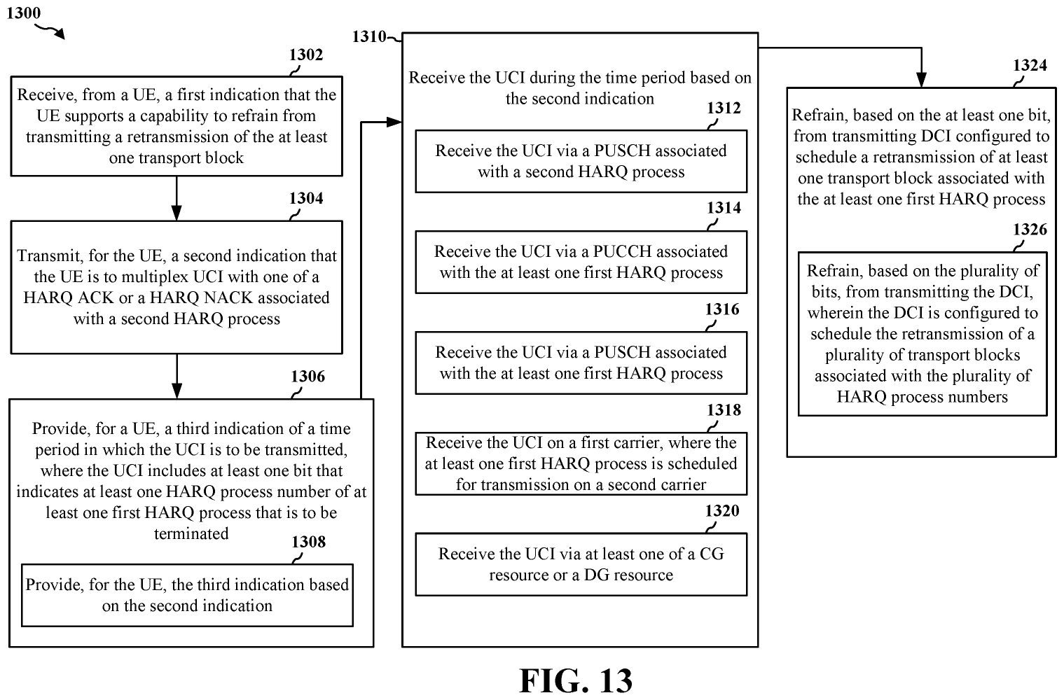

FIG. 13 is a flowchart 1300 illustrating methods of wireless communication at a network node in accordance with various aspects of the present disclosure. In some aspects, the network node may be the base station 102, the base station 310, the network node 402, the network node 902, or the network entity 1502 in the hardware implementation of FIG. 15.

At 1302, the network node may receive, from the UE, a first indication that the UE supports a capability to refrain from transmitting a retransmission of the at least one transport block. For example, referring to FIG. 9, the network node 902, at 906, may receive, from the UE 904, an indication that the UE 904 supports a capability to refrain from transmitting the retransmission of the at least one transport block. In an aspect, 1302 may be performed by the HARQ process early termination component 199.

At 1304, the network node may transmit, for the UE, a second indication that the UE is to multiplex the UCI with one of a HARQ ACK or a HARQ NACK associated with a second HARQ process. For example, referring to FIG. 9, at 908, the network node 902 may transmit, to the UE 904, configuration information that includes an indication that the UE 904 is to multiplex the UCI with one of a HARQ ACK or a HARQ NACK associated with a second HARQ process (e.g., a downlink-based HARQ process that was initiated before the HARQ process initiated at 912). In an aspect, 1304 may be performed by the HARQ process early termination component 199.

At 1306, the network node may provide, for a UE, a third indication of a time period in which UCI is to be transmitted, where the UCI includes at least one bit that indicates at least one HARQ process number of at least one first HARQ process that is to be terminated. For example, referring to FIG. 9, the network node 902, at 908 may provide, for the UE 904, configuration information that includes an indication of a time period in which UCI is to be transmitted, where the UCI includes at least one bit that indicates at least one HARQ process number of at least one first HARQ process that is to be terminated. In an aspect, 1306 may be performed by the HARQ process early termination component 199.

In some aspects, as part of 1306, at 1308, the network node may provide, for the UE, the third indication based on the second indication. For example, referring to FIG. 9, the network node 902, at 906, may receive, from the UE 904, a second indication that the UE 904 supports a capability to refrain from transmitting the retransmission of the at least one transport block. The network node 902 may provide, for the UE 904, the third indication based on the second indication. In an aspect, 1308 may be performed by the HARQ process early termination component 199.

At 1310, the network node may receive the UCI during the time period based on the second indication. For example, referring to FIG. 9, the network node 902, at 918, may receive the UCI during the time period based on the second indication. In an aspect, 1310 may be performed by the HARQ process early termination component 199.

In some aspects, as part of 1310, at 1312, the network node may receive the UCI by receiving the UCI via a PUSCH associated with a second HARQ process. For example, referring to FIG. 9, at 918, the network node 902 may receive the UCI via a PUSCH associated with a second HARQ process. For instance, as shown in FIG. 5B, the network node 902, at 918, may receive the UCI-HPNT associated with a first HARQ process 502 via a PUSCH resource 506 associated with a second process (Process #2). In an aspect, 1312 may be performed by the HARQ process early termination component 199.

In some aspects, as part of 1310, at 1314, the network node may receive the UCI by receiving the UCI via a PUCCH associated with the at least one first HARQ process. For example, referring to FIG. 9, at 918, the network node 902 may receive the UCI via a PUCCH associated with the at least one HARQ process. For instance, as shown in FIG. 5C, the network node 902, at 918, may receive the UCI-HPNT associated with a first HARQ process 502 via a PUCCH resource 508 associated with the first HARQ process 502 (Process #1). In an aspect, 1314 may be performed by the HARQ process early termination component 199.

In some aspects, as part of 1310, at 1316, the network node may receive the UCI by receiving the UCI via a PUSCH associated with the at least one first HARQ process. For example, referring to FIG. 9, at 918, the network node 902 may receive the UCI via a PUSCH associated with the at least one HARQ process. For instance, as shown in FIG. 5A, the network node 902, at 918, may receive the UCI-HPNT associated with a first HARQ process 502 via a PUSCH resource 504 associated with the first HARQ process 502 (Process #1). In an aspect, 1316 may be performed by the HARQ process early termination component 199.

In some aspects, as part of 1310, at 1318, the network node may receive the UCI on a first carrier, where the at least one first HARQ process is scheduled for transmission on a second carrier. For example, referring to FIG. 9, at 918, the network node 902 may receive the UCI on a first carrier, where the at least one first HARQ process is scheduled for transmission on a second carrier. For instance, as shown in FIG. 6, the network node 902, at 918, may receive the UCI-HPNT on a first carrier f1 602 and indicate a HARQ process number of a HARQ process scheduled for transmission a different carrier. For instance, the UCI-HPNT may indicate that a HARQ process 604 (e.g., HARQ Process #3) on a second carrier f3 606 is to be early terminated. In an aspect, 1318 may be performed by the HARQ process early termination component 199.

In some aspects, the at least one bit may be specified in a field configured to store the at least one HARQ process number, where the field is included in at least one of a CG resource or a DG resource. In such aspects, as part of 1310, at 1320, the network node may receive the UCI via at least one of the CG resource or the DG resource. For example, referring to FIG. 8, the at least one bit may be specified in a HARQ process number field of a CG-UCI (or a DG-UCI). The HARQ process number field may be configured to store the at least one HARQ process number, where the field is included in at least one of a CG resource (e.g., the CG-UCI) or a DG resource (e.g., the DG-UCI). Referring to FIG. 9, at 918, the network node 902 may receive the UCI via at least one of the CG resource or the DG resource. In an aspect, 1320 may be performed by the HARQ process early termination component 199.

At 1324, the network node may refrain, based on the at least one bit, from transmitting DCI configured to schedule a retransmission of at least one transport block associated with the at least one first HARQ process. For example, referring to FIG. 9, the network node 902, at 920, may refrain, based on the at least one bit, from transmitting DCI configured to schedule a retransmission of at least one transport block associated with the at least one first HARQ process. In an aspect, 1324 may be performed by the HARQ process early termination component 199.

In some aspects, the UCI may include a plurality of bits that indicates a plurality of HARQ process numbers of a plurality of first HARQs processes that are to be terminated. In such aspects, as part of 1324, at 1326, the network node may refrain from transmitting the DCI by refraining, based on the plurality of bits, from transmitting the DCI, where the DCI is configured to schedule the retransmission of a plurality of transport blocks associated with the plurality of HARQ process numbers. For example, referring to FIG. 9, the UCI received at 918 may include a plurality of bits that indicates a plurality of HARQ process numbers of a plurality of first HARQs processes that are to be terminated. At 920, the network node may refrain from transmitting the DCI to the UE 904 by refraining, based on the plurality of bits, from transmitting the DCI, where the DCI is configured to schedule the retransmission of a plurality of transport blocks associated with the plurality of HARQ process numbers. In an aspect, 1326 may be performed by the HARQ process early termination component 199.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be a processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to obtain a first indication of a time period in which UCI is to be transmitted, where the UCI includes at least one bit that indicates at least one HARQ process number of at least one first HARQ process that is to be terminated at the UE, to transmit the UCI during the time period based on the first indication, and to refrain from a transmission of at least one transport block associated with the at least one first HARQ process based on the at least one bit in the UCI. The component 198 may be configured to perform any of the aspects described in connection with the flowcharts in FIGS. 10 and 11A-11C and/or the aspects performed by the UE 904 in the communication flow in FIG. 9. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for obtaining a first indication of a time period in which up UCI is to be transmitted, where the UCI includes at least one bit that indicates at least one HARQ process number of at least one first HARQ process that is to be terminated at the UE, means for transmitting the UCI during the time period based on the first indication, and means for refraining from transmitting of at least one transport block associated with the at least one first HARQ process based on the at least one bit in the UCI. The apparatus may further include means for performing any of the aspects described in connection with the flowcharts in FIGS. 10 and 11A-11C and/or the aspects performed by the UE 904 in the communication flow in FIG. 9. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, for a UE, a first indication of a time period in which UCI is to be transmitted, where the UCI includes at least one bit that indicates at least one HARQ process number of at least one first HARQ process that is to be terminated, to receive the UCI during the time period based on the first indication, and to refrain, based on the at least one bit, from a transmission of DCI configured to schedule a retransmission of at least one transport block associated with the at least one first HARQ process. The component 199 may be configured to perform any of the aspects described in connection with the flowcharts in FIGS. 12 and 13 and/or the aspects performed by the network node 902 in the communication flow in FIG. 9. The component 199 may be within one or more processors of one or more of the CU(s) 1510, DU(s) 1530, and the RU(s) 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for providing, for a UE, a first indication of a time period in which UCI is to be transmitted, where the UCI includes at least one bit that indicates at least one HARQ process number of at least one first HARQ process that is to be terminated, means for receiving the UCI during the time period based on the first indication, and means for refraining, based on the at least one bit, from transmitting DCI configured to schedule a retransmission of at least one transport block associated with the at least one first HARQ process. The apparatus may further include means for performing any of the aspects described in connection with the flowcharts in FIGS. 12 and 13 and/or the aspects performed by the network node 902 in the communication flow in FIG. 9. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects of the present disclosure, in connection with the accompanying drawings, relate generally to communication systems. Some aspects more specifically relate to the early termination of HARQ process(es). In some examples, a UE may indicate, to a network node, HARQ process number identifier(s) (ID(s)) of HARQ process(es) that are to be early terminated (e.g., due to the expiration of a packet delay budget). The UE may indicate the HARQ process number ID(s) in UCI. The UCI may be transmitted based on a time period specified by the network node. The network node may refrain from transmitting, to the UE, downlink control information (DCI) configured to schedule a retransmission of transport block(s) associated with the HARQ process(es) that are identified in the UCI. The UE may refrain from retransmitting the transport block(s) as a result from not receiving the DCI, as the UE is not scheduled to transmit such transport block(s).

Particular aspects of the subject matter described in this disclosure can be implemented to realize one or more of the following potential advantages. In some examples, by early terminating HARQ process(es), the UE may conserve compute resources (e.g., processing cycles, memory, power, etc.) by limiting the retransmissions of data.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising obtaining a first indication of a time period in which uplink control information (UCI) is to be transmitted, wherein the UCI comprises at least one bit that indicates at least one hybrid automatic repeat request (HARQ) process number of at least one first HARQ process that is to be terminated at the UE; transmitting the UCI during the time period based on the first indication; and refraining from transmitting of at least one transport block associated with the at least one first HARQ process based on the at least one bit in the UCI.

Aspect 2 is the method of aspect 1, wherein obtaining the first indication comprises: receiving the first indication from a network node.

Aspect 3 is the method of any of aspects 1 and 2, wherein obtaining the first indication comprises: obtaining the first indication based on a capability of the UE to support the refraining from transmitting the at least one transport block.

Aspect 4 is the method of any of aspects 1 to 3, further comprising: transmitting a second indication that the UE supports a capability to refrain from transmitting the at least one transport block, wherein obtaining the first indication comprises obtaining the first indication based on the second indication.

Aspect 5 is the method of any of aspects 1 to 4, wherein the UCI comprises a plurality of bits that indicates a plurality of HARQ process numbers of a plurality of first HARQs processes that are to be terminated at the UE, and wherein refraining from transmitting the at least one transport block comprises: refraining from transmitting a plurality of transport blocks associated with the plurality of first HARQ processes based on the plurality of bits.

Aspect 6 is the method of any of aspects 1 to 5, wherein transmitting the UCI comprises: transmitting the UCI via a physical uplink shared channel (PUSCH) associated with a second HARQ process.

Aspect 7 is the method of any of aspects 1 to 5, wherein transmitting the UCI comprises: transmitting the UCI via a physical uplink control channel (PUCCH) associated with the at least one first HARQ process.

Aspect 8 is the method of any of aspects 1 to 5, wherein transmitting the UCI comprises: transmitting the UCI via a physical uplink shared channel (PUSCH) associated with the at least one first HARQ process.

Aspect 9 is the method of any of aspects 1 to 5, wherein transmitting the UCI comprises: transmitting the UCI on a first carrier, wherein the at least one first HARQ process is scheduled for transmission on a second carrier.

Aspect 10 is the method of any of aspects 1 to 5, further comprising: receiving a second indication that the UE is to multiplex the UCI with one of a HARQ acknowledgment (ACK) or a HARQ negative ACK (NACK) associated with a second HARQ process; and multiplexing the UCI with one of the HARQ ACK or the HARQ NACK based on the second indication in order to generate a multiplexed signal comprising one or more bits, wherein transmitting the UCI comprises: transmitting the multiplexed signal.

Aspect 11 is the method of aspect 10, wherein multiplexing the UCI with one of the HARQ ACK or the HARQ NACK comprises: determining that a physical uplink control channel (PUCCH) associated with the at least one first HARQ process overlaps with a physical uplink shared channel (PUSCH) within a PUCCH group associated with the at least one first HARQ process; and jointly encoding the UCI with one of the HARQ ACK or the HARQ NACK based on the determination that the PUCCH associated with the least one first HARQ process overlaps with the PUSCH within the PUCCH group.

Aspect 12 is the method of any of aspects 10 and 11, wherein transmitting the multiplexed signal comprises: determining that the multiplexed signal is to be transmitted in a physical uplink shared channel (PUSCH); and transmitting, based on the determination that the multiplexed signal is to be transmitted in the PUSCH, the multiplexed signal based on a rate matching condition that adapts a number of coded bits associated with the multiplexed signal to a number of available bits in the PUSCH.

Aspect 13 is the method of aspect 12, further comprising: puncturing at least one first bit of the one or more bits of the multiplexed signal.

Aspect 14 is the method of any of aspects 12 and 13, wherein determining that the multiplexed signal is to be transmitted in the PUSCH comprises: determining a number of resources for transmitting the multiplexed signal in the PUSCH based on a beta offset associated with the UCI; and transmitting the multiplexed signal in the PUSCH based on the number of resources.

Aspect 15 is the method of any of aspects 1 to 14, wherein transmitting the UCI based on the time period comprises: transmitting the UCI a plurality of times.

Aspect 16 is the method of any of aspects 1 to 5 and 15, wherein the at least one bit is specified in a field configured to store the at least one HARQ process number, wherein the field is included in at least one of a configured grant (CG) resource or a dynamic grant (DG) resource, and wherein transmitting the UCI comprises: transmitting the UCI via at least one of the CG resource or the DG resource.

Aspect 17 is the method of aspect 16, further comprising: transmitting a new data indicator (NDI) via at least one of the CG resource or the DG resource, wherein the NDI, when set, indicates that the UE is requesting termination of the at least one first HARQ process.

Aspect 18 is the method of any of aspects 16 and 17, further comprising: receiving a second indication that configures the UE to utilize the field to specify the at least one bit.

Aspect 19 is the method of any of aspects 16 to 18, wherein transmitting the UCI via at least one of the CG resource or the DG resource comprises: transmitting the UCI in a physical uplink shared channel (PUSCH) via at least one of the CG resource or the DG resource.

Aspect 20 is a method of wireless communication at a network node, comprising: providing, for a user equipment (UE), a first indication of a time period in which uplink control information (UCI) is to be transmitted, wherein the UCI comprises at least one bit that indicates at least one hybrid automatic repeat request (HARQ) process number of at least one first HARQ process that is to be terminated; receiving the UCI during the time period based on the first indication; and refraining, based on the at least one bit, from transmitting downlink control information (DCI) configured to schedule a retransmission of at least one transport block associated with the at least one first HARQ process.

Aspect 21 is the method of aspect 20, further comprising: receiving, from the UE, a second indication that the UE supports a capability to refrain from transmitting the retransmission of the at least one transport block, wherein providing, for the UE, the first indication comprises: providing, for the UE, the first indication based on the second indication.

Aspect 22 is the method of any of aspects 20 and 21, wherein the UCI comprises a plurality of bits that indicates a plurality of HARQ process numbers of a plurality of first HARQs processes that are to be terminated, and wherein refraining from transmitting the DCI comprises: refraining, based on the plurality of bits, from transmitting the DCI, wherein the DCI is configured to schedule the retransmission of a plurality of transport blocks associated with the plurality of HARQ process numbers.

Aspect 23 is the method of any of aspects 20 to 22, wherein receiving the UCI comprises: receiving the UCI via a physical uplink shared channel (PUSCH) associated with a second HARQ process.

Aspect 24 is the method of any of aspects 20 to 22, wherein receiving the UCI comprises: receiving the UCI via a physical uplink control channel (PUCCH) associated with the at least one first HARQ process.

Aspect 25 is the method of any of aspects 20 to 22, wherein receiving the UCI comprises: receiving the UCI via a physical uplink shared channel (PUSCH) associated with the at least one first HARQ process.

Aspect 26 is the method of any of aspects 20 to 22, wherein receiving the UCI comprises: receiving the UCI on a first carrier, wherein the at least one first HARQ process is scheduled for transmission on a second carrier.

Aspect 27 is the method of any of aspects 20 to 22, further comprising: transmitting, for the UE, a second indication that the UE is to multiplex the UCI with one of a HARQ acknowledgment (ACK) or a HARQ negative ACK (NACK) associated with a second HARQ process.

Aspect 28 is the method of any of aspects 20 to 22, wherein the at least one bit is specified in a field configured to store the at least one HARQ process number, wherein the field is included in at least one of a configured grant (CG) resource or a dynamic grant (DG) resource, and wherein receiving the UCI comprises: receiving the UCI via at least one of the CG resource or the DG resource.

Aspect 29 is an apparatus for wireless communication at a UE. The apparatus includes at least one memory; and at least one processor coupled to the at least one memory and, based at least in part on information stored in the at least one memory, the at least one processor, individually or in any combination, is configured to implement any of aspects 1 to 19.

Aspect 30 is the apparatus of aspect 29, further including at least one of a transceiver or an antenna coupled to the at least one processor.

Aspect 31 is an apparatus for wireless communication at a network node. The apparatus includes at least one memory; and at least one processor coupled to the at least one memory and, based at least in part on information stored in the at least one memory, the at least one processor, individually or in any combination, is configured to implement any of aspects 20 to 28.

Aspect 32 is the apparatus of aspect 31, further including at least one of a transceiver or an antenna coupled to the at least one processor.

Aspect 33 is an apparatus for wireless communication including means for implementing any of aspects 1 to 19.

Aspect 34 is an apparatus for wireless communication including means for implementing any of aspects 20 to 28.

Aspect 35 is a computer-readable medium (e.g., a non-transitory computer-readable medium) storing computer executable code, where the code when executed by at least one processor causes the at least one processor, individually or in any combination, to implement any of aspects 1 to 19.

Aspect 35 is a computer-readable medium (e.g., a non-transitory computer-readable medium) storing computer executable code, where the code when executed by at least one processor causes the at least one processor, individually or in any combination, to implement any of aspects 20 to 28.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
obtain a first indication of a time period in which uplink control information (UCI) is to be transmitted, wherein the UCI comprises at least one bit that indicates at least one hybrid automatic repeat request (HARQ) process number of at least one first HARQ process that is to be terminated at the UE;
transmit the UCI during the time period based on the first indication; and
refrain from a transmission of at least one transport block associated with the at least one first HARQ process based on the at least one bit in the UCI.

2. The apparatus of claim 1, wherein, to obtain the first indication, the at least one processor, individually or in any combination, is configured to:
receive the first indication from a network node.

3. The apparatus of claim 1, wherein, to obtain the first indication, at least one processor, individually or in any combination, is configured to:
obtain the first indication based on a capability of the UE to support the refrain from the transmission of the at least one transport block.

4. The apparatus of claim 1, wherein the at least one processor, individually or in any combination, is further configured to:
transmit a second indication that the UE supports a capability to refrain from the transmission of the at least one transport block, wherein, to obtain the first indication, the at least one processor, individually or in any combination, is configured to:
obtain the first indication based on the second indication.

5. The apparatus of claim 1, wherein the UCI comprises a plurality of bits that indicates a plurality of HARQ process numbers of a plurality of first HARQ processes that are to be terminated at the UE, and wherein, to refrain from the transmission of the at least one transport block, the at least one processor, individually or in any combination, is configured to:
refrain from a transmission of a plurality of transport blocks associated with the plurality of first HARQ processes based on the plurality of bits.

6. The apparatus of claim 1, wherein, to transmit the UCI, the at least one processor, individually or in any combination, is configured to:
transmit the UCI via a physical uplink shared channel (PUSCH) associated with a second HARQ process.

7. The apparatus of claim 1, wherein, to transmit the UCI, the at least one processor, individually or in any combination, is configured to:
transmit the UCI via a physical uplink control channel (PUCCH) associated with the at least one first HARQ process.

8. The apparatus of claim 1, wherein, to transmit the UCI, the at least one processor, individually or in any combination, is configured to:
transmit the UCI via a physical uplink shared channel (PUSCH) associated with the at least one first HARQ process.

9. The apparatus of claim 1, wherein, to transmit the UCI, the at least one processor, individually or in any combination, is configured to:
schedule the at least one first HARQ process for transmission on a first carrier; and
transmit the UCI on a second carrier.

10. The apparatus of claim 1, wherein the at least one processor, individually or in any combination, is configured to:
receive a second indication that the UE is to multiplex the UCI with one of a HARQ acknowledgment (ACK) or a HARQ negative ACK (NACK) associated with a second HARQ process; and
multiplex the UCI with the one of the HARQ ACK or the HARQ NACK based on the second indication in order to generate a multiplexed signal comprising one or more bits,
wherein, to transmit the UCI, the at least one processor, individually or in any combination, is configured to:
transmit the multiplexed signal.

11. The apparatus of claim 10, wherein, to multiplex the UCI with the one of the HARQ ACK or the HARQ NACK, the at least one processor, individually or in any combination, is configured to:
determine that a physical uplink control channel (PUCCH) associated with the at least one first HARQ process overlaps with a physical uplink shared channel (PUSCH) within a PUCCH group associated with the at least one first HARQ process; and
jointly encode the UCI with the one of the HARQ ACK or the HARQ NACK based on the determination that the PUCCH associated with the least one first HARQ process overlaps with the PUSCH within the PUCCH group.

12. The apparatus of claim 10, wherein, to transmit the multiplexed signal, the at least one processor, individually or in any combination, is configured to:
determine that the multiplexed signal is to be transmitted in a physical uplink shared channel (PUSCH); and
transmit, based on the determination that the multiplexed signal is to be transmitted in the PUSCH, the multiplexed signal based on a rate matching condition that is configured to adapt a number of coded bits associated with the multiplexed signal to a number of available bits in the PUSCH.

13. The apparatus of claim 12, wherein the at least one processor, individually or in any combination, is further configured to:
puncture at least one first bit of the one or more bits of the multiplexed signal.

14. The apparatus of claim 12, wherein, to determine that the multiplexed signal is to be transmitted in the PUSCH, the at least one processor, individually or in any combination, is configured to:
determine a number of resources for transmission of the multiplexed signal in the PUSCH based on a beta offset associated with the UCI; and
transmit the multiplexed signal in the PUSCH based on the number of resources.

15. The apparatus of claim 1, wherein, to transmit the UCI based on the time period, the at least one processor, individually or in any combination, is configured to:
transmit the UCI a plurality of times.

16. The apparatus of claim 1, wherein the at least one bit is specified in a field configured to store the at least one HARQ process number, wherein the field is included in at least one of a configured grant (CG) resource or a dynamic grant (DG) resource, and wherein, to transmit the UCI, the at least one processor, individually or in any combination, is configured to:
transmit the UCI via at least one of the CG resource or the DG resource.

17. The apparatus of claim 16, wherein the at least one processor, individually or in any combination, is configured to:
transmit a new data indicator (NDI) via at least one of the CG resource or the DG resource, wherein the NDI, when set, indicates that the UE is requesting termination of the at least one first HARQ process.

18. The apparatus of claim 16, wherein the at least one processor, individually or in any combination, is configured to:
receive a second indication that configures the UE to utilize the field to specify the at least one bit.

19. The apparatus of claim 16, wherein, to transmit the UCI via at least one of the CG resource or the DG resource, the at least one processor, individually or in any combination, is configured to:
transmit the UCI in a physical uplink shared channel (PUSCH) via at least one of the CG resource or the DG resource.

20. An apparatus for wireless communication at a network node, comprising:
at least one memory; and
at least one processor coupled to the at least one memory and, based at least in part on information stored in the at least one memory, the at least one processor, individually or in any combination, is configured to:
provide, for a user equipment (UE), a first indication of a time period in which uplink control information (UCI) is to be transmitted, wherein the UCI comprises at least one bit that indicates at least one hybrid automatic repeat request (HARQ) process number of at least one first HARQ process that is to be terminated;
receive the UCI during the time period based on the first indication; and
refrain, based on the at least one bit, from a transmission of downlink control information (DCI) configured to schedule a retransmission of at least one transport block associated with the at least one first HARQ process.

21. The apparatus of claim 20, wherein the at least one processor, individually or in any combination, is further configured to:
receive, from the UE, a second indication that the UE supports a capability to refrain from the retransmission of the at least one transport block, wherein to provide, for the UE, the first indication, the at least one processor is configured to:
provide, for the UE, the first indication based on the second indication.

22. The apparatus of claim 20, wherein the UCI comprises a plurality of bits that indicates a plurality of HARQ process numbers of a plurality of first HARQs processes that are to be terminated, and wherein, to refrain, from transmission of the DCI, the at least one processor, individually or in any combination, is configured to:
refrain, based on the plurality of bits, from the transmission of the DCI, wherein the DCI is configured to schedule the retransmission of a plurality of transport blocks associated with the plurality of HARQ process numbers.

23. The apparatus of claim 20, wherein, to receive the UCI, the at least one processor, individually or in any combination, is configured to:
receive the UCI via a physical uplink shared channel (PUSCH) associated with a second HARQ process.

24. The apparatus of claim 20, wherein, to receive the UCI, the at least one processor, individually or in any combination, is configured to:
receive the UCI via a physical uplink control channel (PUCCH) associated with the at least one first HARQ process.

25. The apparatus of claim 20, wherein, to receive the UCI, the at least one processor, individually or in any combination, is configured to:
receive the UCI via a physical uplink shared channel (PUSCH) associated with the at least one first HARQ process.

26. The apparatus of claim 20, wherein, to receive the UCI, the at least one processor, individually or in any combination, is configured to:
receive the UCI on a first carrier, wherein the at least one first HARQ process is scheduled for transmission on a second carrier.

27. The apparatus of claim 20, wherein the at least one processor, individually or in any combination, is further configured to:
transmit, for the UE, a second indication that the UE is to multiplex the UCI with one of a HARQ acknowledgment (ACK) or a HARQ negative ACK (NACK) associated with a second HARQ process.

28. The apparatus of claim 20, wherein the at least one bit is specified in a field configured to store the at least one HARQ process number, wherein the field is included in at least one of a configured grant (CG) resource or a dynamic grant (DG) resource, and wherein, to receive the UCI, the at least one processor, individually or in any combination, is configured to:
receive the UCI via at least one of the CG resource or the DG resource.

29. A method for wireless communication at a user equipment (UE), comprising:
obtaining a first indication of a time period in which uplink control information (UCI) is to be transmitted, wherein the UCI comprises at least one bit that indicates at least one hybrid automatic repeat request (HARQ) process number of at least one first HARQ process that is to be terminated at the UE;
transmitting the UCI during the time period based on the first indication; and
refraining from transmitting of at least one transport block associated with the at least one first HARQ process based on the at least one bit in the UCI.

30. A method for wireless communication at a network node, comprising:
providing, for a user equipment (UE), a first indication of a time period in which uplink control information (UCI) is to be transmitted, wherein the UCI comprises at least one bit that indicates at least one hybrid automatic repeat request (HARQ) process number of at least one first HARQ process that is to be terminated;
receiving the UCI during the time period based on the first indication; and
refraining, based on the at least one bit, from transmitting downlink control information (DCI) configured to schedule a retransmission of at least one transport block associated with the at least one first HARQ process.
